(19) United States
(12) Patent Application Publication
(10) Pub. No.: US 2025/0013139 A1
(43) Pub. Date: Jan. 9, 2025

(54) PROJECTION LASER SOURCE AND PROJECTION APPARATUS

(71) Applicant: HISENSE LASER DISPLAY CO., LTD, Qingdao (CN)

(72) Inventors: Wei LI, Qingdao (CN); Xiaoqiang GU, Qingdao (CN); Youliang TIAN, Qingdao (CN)

(73) Assignee: HISENSE LASER DISPLAY CO., LTD, Qingdao (CN)

(21) Appl. No.: 18/895,128

(22) Filed: Sep. 24, 2024

Related U.S. Application Data
(63) Continuation of application No. PCT/CN2023/084181, filed on Mar. 27, 2023.

(30) Foreign Application Priority Data
Mar. 31, 2022 (CN) 202210337489.6
Mar. 31, 2022 (CN) 202210337502.8

(51) Int. Cl. G03B 21/20; G02B 27/14

(52) U.S. Cl. CPC G03B 21/2033; G02B 27/141

(57) ABSTRACT

A projection laser source includes a laser device, a light guide lens group, a first combining lens, and a second combining lens. The light guide lens group is configured to adjust laser beams emitted by the first sub-region and the second sub-region to be emitted towards the first combining lens and the second combining lens, respectively, from a side of the third laser-exit region away from the second laser-exit region. A laser beam emitted by a region other than the first sub-region in the first laser-exit region is emitted to the first combining lens. A laser beam emitted by a region other than the second sub-region in the second laser-exit region and a laser beam emitted by the third laser-exit region are emitted to the second combining lens. The first combining lens and the second combining lens are configured to emit the incident laser beam along the first direction.

### CROSS-REFERENCE TO RELATED APPLICATIONS

This application is a continuation application of International Application No. PCT/CN2023/084181, filed on Mar. 27, 2023, which claims priority to Chinese Patent Application No. 202210337489.6, filed on Mar. 31, 2022, and Chinese Patent Application No. 202210337502.8, filed on Mar. 31, 2022, which are incorporated herein by reference in their entireties.

### TECHNICAL FIELD

The present disclosure relates to the field of photoelectric technologies and, in particular, to a projection laser source and a projection apparatus.

### BACKGROUND

With the development of photoelectric technologies, projection apparatuses are widely used. The projection laser source in the projection apparatus may emit laser beams of a plurality of colors, and a projection image may be formed based on the laser beams. The higher the symmetry of the laser beams of the plurality of colors emitted by the projection laser source, the better the mixing effect, and the better the display effect of the projection image.

### SUMMARY

In an aspect, a projection laser source is provided, and includes a laser device, a light guide lens group, a first combining lens, and a second combining lens. The laser device includes a first laser-exit region, a second laser-exit region, and a third laser-exit region configured to respectively emit laser beams of different colors. The second laser-exit region and the third laser-exit region are located at a same side of the first laser-exit region in a first direction and are arranged along a second direction. The first direction is perpendicular to the second direction. The second laser-exit region includes a second sub-region, and the second sub-region is a partial region of an end of the second laser-exit region away from the third laser-exit region. The first laser-exit region includes a first sub-region. Along the first direction, the first sub-region is a partial region of the first laser-exit region corresponding to the second sub-region. The light guide lens group is configured to adjust a laser beam emitted by the first sub-region and a laser beam emitted by the second sub-region to be emitted towards the first combining lens and the second combining lens, respectively, from a side of the third laser-exit region away from the second laser-exit region. A laser beam emitted by a region other than the first sub-region in the first laser-exit region is emitted to the first combining lens. A laser beam emitted by a region other than the second sub-region in the second laser-exit region and a laser beam emitted by the third laser-exit region are emitted to the second combining lens. The first combining lens and the second combining lens are located at a side of the light guide lens group away from the laser device, and the first combining lens and the second combining lens are configured to emit the incident laser beam along the first direction.

In another aspect, a projection apparatus is provided and includes: the projection laser source as described in any one of the embodiments, a light valve, and a projection lens. The projection laser source is configured to emit laser beam towards the light valve. The light valve is configured to modulate and emit the incident laser beam towards the projection lens. The projection lens is configured to project the incident laser beam to provide a projection image.

In yet another aspect, a projection laser source is provided and includes a laser device, a diffusion component, a first light guide lens group, a second light guide lens group, and a dichroic combining lens. The laser device includes a first laser-exit region, a second laser-exit region, and a third laser-exit region. The first laser-exit region is packaged and configured to emit a first laser beam. The second laser-exit region is configured to emit a second laser beam. The third laser-exit region is configured to emit a third laser beam. The second laser-exit region and the third laser-exit region are packaged. Colors of the first laser beam, the second laser beam, and the third laser beam are different. The diffusion component is parallel to a laser-exit surface of the laser device and configured to diffuse the first laser beam, the second laser beam, and the third laser beam. The first light guide lens group is configured to reflect and guide the second laser beam to a dichroic combining lens. The second light guide lens group is configured to guide the third laser beam to the dichroic combining lens. The dichroic combining lens is configured to reflect the first laser beam from the diffusion component in a predetermined direction and transmit the third laser beam from the second light guide lens group and the second laser beam from the first light guide lens group in the predetermined direction, so as to form a mixed laser beam.

In yet another aspect, a projection apparatus is provided and includes: the projection laser source as described in any one of the embodiments, a second converging lens, a diffusion wheel, and a third fly-eye lens. The projection laser source is configured to output a mixed laser beam provided by mixing the first laser beam, the second laser beam, and the third laser beam. The second converging lens is located at a laser-exit side of the projection laser source and configured to converge the mixed laser beam. The diffusion wheel is located at a laser-exit side of the second converging lens and configured to diffuse the converged mixed laser beam. The third fly-eye lens is located at a laser-exit side of the diffusion wheel and configured to homogenize the diffused mixed laser beam.

### BRIEF DESCRIPTION OF THE DRAWINGS

FIG. 1 is a schematic structural diagram of a projection laser source, in accordance with the related art;

FIG. 2 is a schematic diagram of beam spots formed by laser beams emitted by a combining lens group, in accordance with the related art;

FIG. 3A is a perspective view of a projection laser source, in accordance with some embodiments of the present disclosure;

FIG. 3B is a perspective view of another projection laser source, in accordance with some embodiments of the present disclosure;

FIG. 4A is a side view of a projection laser source, in accordance with some embodiments of the present disclosure;

FIG. 4B is a side view of another projection laser source, in accordance with some embodiments of the present disclosure;

FIG. 5A is a front view of a projection laser source, in accordance with some embodiments of the present disclosure;

FIG. 5B is a top view of another projection laser source, in accordance with some embodiments of the present disclosure;

FIG. 6A is a top view of a projection laser source, in accordance with some embodiments of the present disclosure;

FIG. 6B is a top view of yet another projection laser source, in accordance with some embodiments of the present disclosure;

FIG. 7A is a schematic diagram of beam spots formed by laser beams emitted by a projection laser source, in accordance with some embodiments of the present disclosure;

FIG. 7B is a schematic diagram of beam spots formed by laser beams emitted by another projection laser source, in accordance with some embodiments of the present disclosure;

FIG. 7C is a schematic diagram of beam spots formed by laser beams emitted by yet another projection laser source, in accordance with some embodiments of the present disclosure;

FIG. 8A is a perspective view of a projection laser source provided with reflecting sub-regions, in accordance with some embodiments of the present disclosure;

FIG. 8B is a perspective view of another projection laser source provided with reflecting sub-regions, in accordance with some embodiments of the present disclosure;

FIG. 8C is a side view of another projection laser source provided with reflecting sub-regions, in accordance with some embodiments of the present disclosure;

FIG. 9 is a structural diagram of a laser device, in accordance with some embodiments of the present disclosure;

FIG. 10 is a cross-sectional view taken along a line A-A′ in FIG. 9;

FIG. 11 is a schematic diagram of beam spots formed by laser beams emitted by a projection laser source, in accordance with the related art;

FIG. 12A is a side view of a projection laser source provided with a fly-eye lens, in accordance with some embodiments of the present disclosure;

FIG. 12B is a side view of another projection laser source provided with a fly-eye lens, in accordance with some embodiments of the present disclosure;

FIG. 13A is a perspective view of a projection laser source provided with a diffusion region, in accordance with some embodiments of the present disclosure;

FIG. 13B is a perspective view of another projection laser source provided with a diffusion region, in accordance with some embodiments of the present disclosure;

FIG. 14 is a structural diagram of yet another projection laser source, in accordance with some embodiments of the present disclosure;

FIG. 15 is a structural diagram of yet another projection laser source, in accordance with some embodiments of the present disclosure;

FIG. 16 is a structural diagram of yet another projection laser source, in accordance with some embodiments of the present disclosure;

FIG. 17 is a structural diagram of a projection apparatus, in accordance with some embodiments of the present disclosure; and

FIG. 18 is a structural diagram of another projection apparatus, in accordance with some embodiments of the present disclosure.

### DETAILED DESCRIPTION

Some embodiments of the present disclosure will be clearly and completely described below with reference to the accompanying drawings. However, the described embodiments are merely some but not all embodiments of the present disclosure. All other embodiments obtained by a person of ordinary skill in the art based on embodiments of the present disclosure shall be included in the protection scope of the present disclosure.

Unless the context requires otherwise, throughout the specification and the claims, the term “comprise” and other forms thereof such as the third-person singular form “comprises” and the present participle form “comprising” are construed as an open and inclusive meaning, i.e., “including, but not limited to.” In the description of the specification, the terms such as “one embodiment,” “some embodiments,” “exemplary embodiments,” “example,” “specific example,” or “some examples” are intended to indicate that specific features, structures, materials, or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics may be included in any one or more embodiments or examples in any suitable manner.

The terms “first” and “second” are used for descriptive purposes only, and are not to be construed as indicating or implying a relative importance or implicitly indicating a number of indicated technical features. Thus, features defined by “first” or “second” may explicitly or implicitly include one or more of the features. In the description of the embodiments of the present disclosure, the term “a plurality of” or “the plurality of” means two or more unless otherwise specified.

In the description of some embodiments, the terms such as “connected” and derivatives thereof may be used. The term “connected” should be understood in a broad sense. For example, the term “connected” may represent a fixed connection, a detachable connection, or a one-piece connection, or may represent a direct connection, or may represent an indirect connection through an intermediate medium.

The phrase “at least one of A, B, and C” has the same meaning as the phrase “at least one of A, B, or C,” both including the following combinations of A, B, and C: only A, only B, only C, a combination of A and B, a combination of A and C, a combination of B and C, and a combination of A, B, and C.

The phrase “A and/or B” includes following three combinations: only A, only B, and a combination of A and B.

The phrase “applicable to” or “configured to” as used herein indicates an open and inclusive expression, which does not exclude apparatuses that are applicable to or configured to perform additional tasks or steps.

The term such as “about,” “substantially,” and “approximately” as used herein includes a stated value and an average value within an acceptable range of deviation of a particular value. The acceptable range of deviation is determined by a person of ordinary skill in the art, considering measurement in question and errors associated with measurement of a particular quantity (i.e., limitations of a measurement system).

The term such as “parallel,” “perpendicular,” or “equal” as used herein includes a stated condition and a condition similar to the stated condition. A range of the similar condition is within an acceptable deviation range, and the acceptable deviation range is determined by a person of ordinary skill in the art, considering measurement in question and errors associated with measurement of a particular quantity (i.e., the limitations of a measurement system). For example, the term “parallel” includes absolute parallelism and approximate parallelism, and an acceptable range of deviation of the approximate parallelism may be, for example, a deviation within 5°; and the term “perpendicular” includes absolute perpendicularity and approximate perpendicularity, and an acceptable range of deviation of the approximate perpendicularity may also be, for example, a deviation within 5°. The term “equal” includes absolute equality and approximate equality, and an acceptable range of deviation of the approximate equality may be, for example, a difference between two equals of less than or equal to 5% of either of the two equals.

With the development of optoelectronic technology, projection apparatuses are used more and more widely, and requirements for display effect of projection images projected by the projection apparatus are also getting higher and higher. A projection laser source in the projection apparatus is configured to emit laser beams of a plurality of colors. The higher the symmetry, the higher the overlap, and the higher the light mixing uniformity of the laser beams of the plurality of colors, the better the display effect of the projection image formed based on the laser beams.

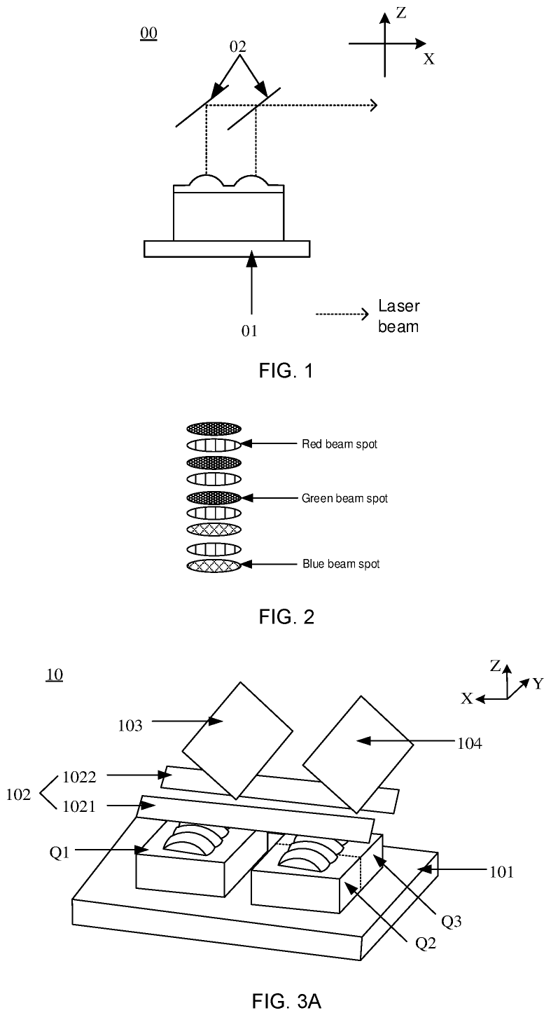

FIG. 1 is a schematic structural diagram of a projection laser source, in accordance with the related art. As shown in FIG. 1, the projection laser source 00 includes a laser device 01 and a combining lens group 02. The laser device 01 may include two columns of light-emitting chips, and one column of the two columns of light-emitting chips is configured to emit a red laser beam. A first portion of the light-emitting chips in another column of light-emitting chips is configured to emit a green laser beam, and a second portion of the light-emitting chips in the another column of light-emitting chips is configured to emit a blue laser beam. The combining lens group 02 may include two combining lenses, each of which is located on a laser-exit side of a corresponding column of light-emitting chips and is configured to emit the laser beam emitted by the corresponding column of light-emitting chips transmitted along a Z direction to an X direction, so as to achieve mixing of the laser beams of the plurality of colors emitted by the laser device 01.

In the related art, after the laser beams in the projection laser source are emitted through the combining lens group, the laser beams need to pass through a light homogenizing component to be homogenized before subsequent image projection. The closer the incident angles of the laser beams on the light homogenizing component is, the closer the homogenizing effect of the light homogenizing component on the laser beams is. The distribution positions of the beam spots may reflect the incident angles of the laser beams on the light homogenizing component.

For example, the closer the beam spots are to the two ends, the larger the incident angles of the laser beams are, and the closer the beam spots are to the center, the less the incident angles of the laser beams are. FIG. 2 is a schematic diagram of beam spots formed by laser beams emitted by a combining lens group, in accordance with the related art. The beam spots formed by the laser beams on the light homogenizing component are similar to the beam spots shown in FIG. 2. Since the incident angles of the red laser beams, green laser beams, and blue laser beams on the light homogenizing component are quite different, the homogenizing effect of the light homogenizing component on the laser beams of different colors is quite different, and the display effect of the projection image formed based on the laser beam is poor.

Some embodiments of the present disclosure provide a projection laser source and a projection apparatus. Laser beams of a plurality of colors emitted by the projection laser source have high symmetry and good light mixing effect and may provide a projection image with good display effect.

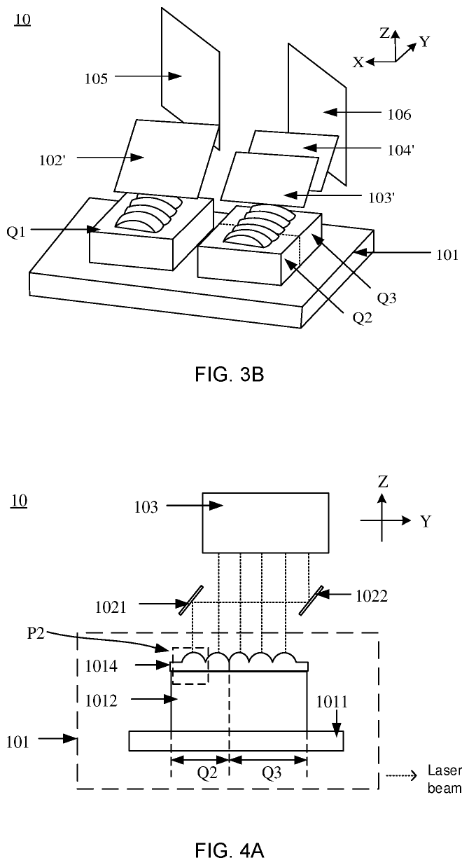

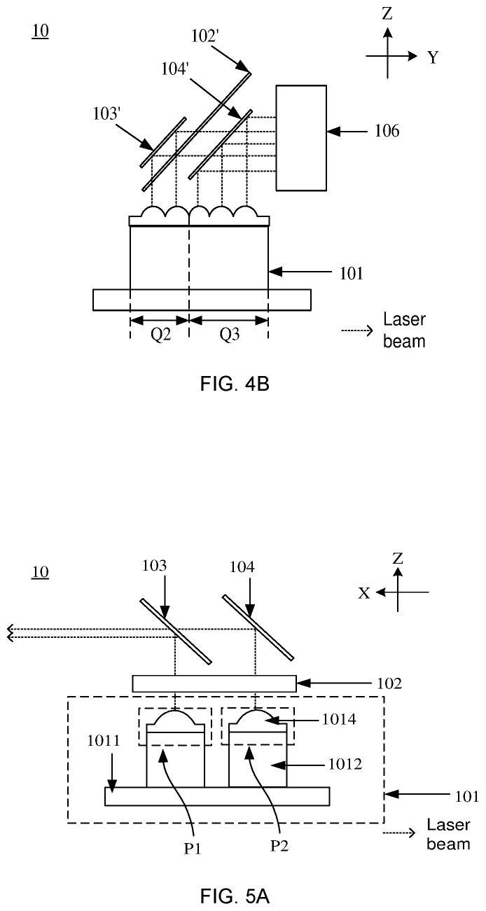

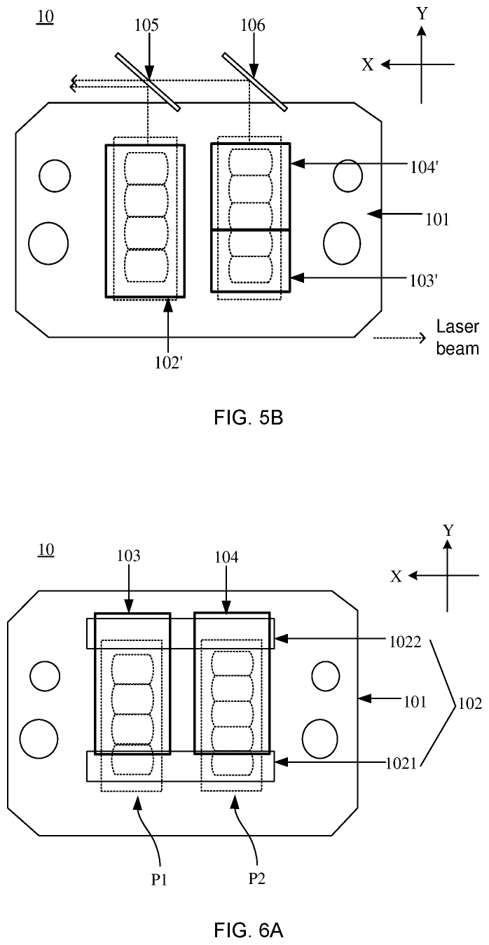

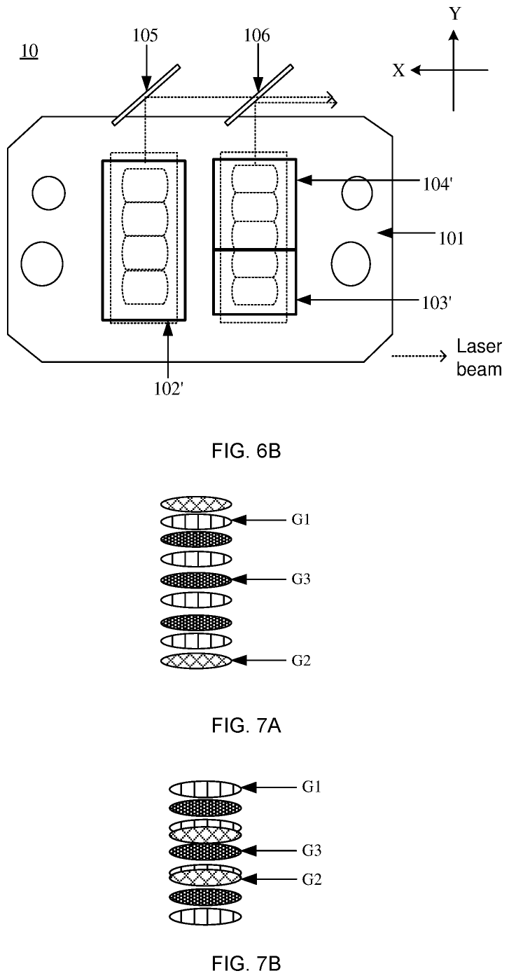

FIG. 3A is a perspective view of a projection laser source, in accordance with some embodiments of the present disclosure; FIG. 4A is a side view of a projection laser source, in accordance with some embodiments of the present disclosure; FIG. 5A is a front view of a projection laser source, in accordance with some embodiments of the present disclosure; and FIG. 6A is a top view of a projection laser source, in accordance with some embodiments of the present disclosure.

As shown in FIGS. 3A, 4A, 5A, and 6A, the projection laser source 10 may include: a laser device 101, a light guide lens group 102, a first combining lens 103, and a second combining lens 104. The laser device 101 may emit laser beam along a third direction (e.g., a Z direction). The light guide lens group 102, the first combining lens 103, and the second combining lens 104 are located at a laser-exit side of the laser device 101, and the first combining lens 103 and the second combining lens 104 are located at a side of the light guide lens group 102 away from the laser device 101.

In some embodiments, the laser device 101 may include a first laser-exit region Q1, a second laser-exit region Q2, and a third laser-exit region Q3. Any one of the first laser-exit region Q1, the second laser-exit region Q2, and the third laser-exit region Q3 is configured to emit a laser beam of one color, and the colors of the laser beams emitted by different laser-exit regions are different. The second laser-exit region Q2 and the third laser-exit region Q3 are located at a same side of the first laser-exit region Q1 in a first direction (e.g., the X direction). The second laser-exit region Q2 and the third laser-exit region Q3 are disposed along a second direction (e.g., the Y direction). The first direction is perpendicular to the second direction, and the first direction and the second direction are respectively perpendicular to the third direction.

In some embodiments, the first laser-exit region Q1 may be rectangular. The first direction may be a length direction of the rectangle, and the second direction may be a width direction of the rectangle.

In some embodiments, as shown in FIG. 3A, the second laser-exit region Q2, and the third laser-exit region Q3 are located at a right side of the first laser-exit region Q1. The second laser-exit region Q2 and the first laser-exit region Q1 are disposed along the X direction, and the third laser-exit region Q3 and the first laser-exit region Q1 are disposed along the X direction.

In some embodiments, the second laser-exit region Q2 and the third laser-exit region Q3 may also be located at a left side of the first laser-exit region Q1. The second laser-exit region Q2 and the first laser-exit region Q1 may also be disposed in an opposite direction of the X direction, and the third laser-exit region Q3 and the first laser-exit region Q1 may also be disposed in the opposite direction of the X direction. In some embodiments, the positions of the second laser-exit region Q2 and the third laser-exit region Q3 in FIG. 3A may also be swapped with each other and, accordingly, the second direction may be an opposite direction of the Y direction.

In some embodiments, as shown in FIG. 3A, the first combining lens 103 may correspond to the first laser-exit region Q1, and the second combining lens 104 may correspond to the second laser-exit region Q2 and the third laser-exit region Q3. The first combining lens 103 and the second combining lens 104 are disposed in the first direction. The laser beam emitted by the first laser-exit region Q1 may be transmitted to the first combining lens 103, and the laser beam emitted by the second laser-exit region Q2 and the third laser-exit region Q3 may be transmitted to the second combining lens 104. Furthermore, the first combining lens 103 and the second combining lens 104 may adjust the transmitting directions of the incident laser beams, so as to achieve mixing of the laser beams emitted by the plurality of laser-exit regions.

In some embodiments, as shown in FIGS. 4A and 5A, the second laser-exit region Q2 includes a second sub-region P2, and the second sub-region P2 is a partial region of an end portion of the second laser-exit region Q2 away from the third laser-exit region Q3. The first laser-exit region Q1 includes a first sub-region P1, and the first sub-region P1 is a partial region of the first laser-exit region Q1 located at the end portion. For example, along the first direction, a partial region in the first laser-exit region Q1 corresponding to the second sub-region P2 is the first sub-region P1. The first sub-region P1 and the second sub-region P2 are partial regions located at a same end portion of the first laser-exit region Q1 and the second laser-exit region Q2 respectively. In some embodiments, the first sub-region P1 and the second sub-region P2 may be aligned in the first direction. For example, ends of the first sub-region P1 and the second sub-region P2 proximate to other regions in the laser-exit regions are aligned in the first direction. Areas of the first sub-region P1 and the second sub-region P2 may be equal or unequal, which is not limited in some embodiments of the present disclosure.

An orthogonal projection of the light guide lens group 102 on the laser device 101 may cover the first sub-region P1 in the first laser-exit region Q1 and the second sub-region P2 in the second laser-exit region Q2. The laser beams emitted by the first sub-region P1 and the second sub-region P2 may be emitted towards the light guide lens group 102 along the third direction.

The light guide lens group 102 may adjust the laser beam emitted by the first sub-region P1 to the first combining lens 103 from a side of the third laser-exit region Q3 away from the second laser-exit region Q2. The light guide lens group 102 may further adjust the laser beam emitted by the second sub-region P2 to the second combining lens 104 from the side of the third laser-exit region Q3 away from the second laser-exit region Q2.

The laser beams emitted by a region of the first laser-exit region Q1 other than the first sub-region P1 may be directly emitted to the first combining lens 103, and the laser beams emitted by a region of the second laser-exit region Q2 other than the second sub-region P2 and the third laser-exit region Q3 may be directly emitted to the second combining lens 104.

The first combining lens 103 and the second combining lens 104 are disposed along the first direction or in a direction opposite to the first direction. On a reference plane perpendicular to the first direction, an orthogonal projection of the first combining lens 103 at least partially overlaps with an orthogonal projection of the second combining lens 104. The first combining lens 103 and the second combining lens 104 are respectively configured to emit an incident laser beam along a first direction.

It will be noted that the reference plane described in some embodiments of the present disclosure is an imaginary plane used to describe the position and size relationship between a plurality of components and may not be a plane that actually exists in the projection laser source.

Some embodiments of the present disclosure are introduced by taking an example in which the first direction is the X direction, the second laser-exit region Q2 and the first laser-exit region Q1, the third laser-exit region Q3 and the first laser-exit region Q1, and the second combining lens 104 and the first combining lens 103 are respectively disposed along the X direction, and the first combining lens 103 and the second combining lens 104 are respectively configured to emit the laser beam along the X direction.

In some embodiments, the first direction may also be an opposite direction of the X direction. The second laser-exit region Q2 and the first laser-exit region Q1, the third laser-exit region Q3 and the first laser-exit region Q1, and the second combining lens 104 and the first combining lens 103 may still be disposed along the X direction. The first combining lens 103 and the second combining lens 104 may emit the laser beam along the opposite direction of the X direction.

For convenience of description, the laser beam emitted by the first laser-exit region Q1 is referred to as a first laser beam, the laser beam emitted by the second laser-exit region Q2 is referred to as a second laser beam, and the laser beam emitted by the third laser-exit region Q3 is referred to as a third laser beam.

For example, the first combining lens 103 is a dichroic mirror, and the second combining lens 104 is a full-band reflector. The second combining lens 104 may reflect the incident second laser beam and third laser beam along the first direction towards the first combining lens 103. The first combining lens 103 may transmit the second laser beam and the third laser beam reflected by the second combining lens 104 along the first direction and reflect the first laser beam along the first direction.

In some embodiments, the second combining lens 104 may further be a dichroic mirror. The second combining lens 104 may reflect the second laser beam and the third laser beam and may transmit or reflect the laser beams of other colors.

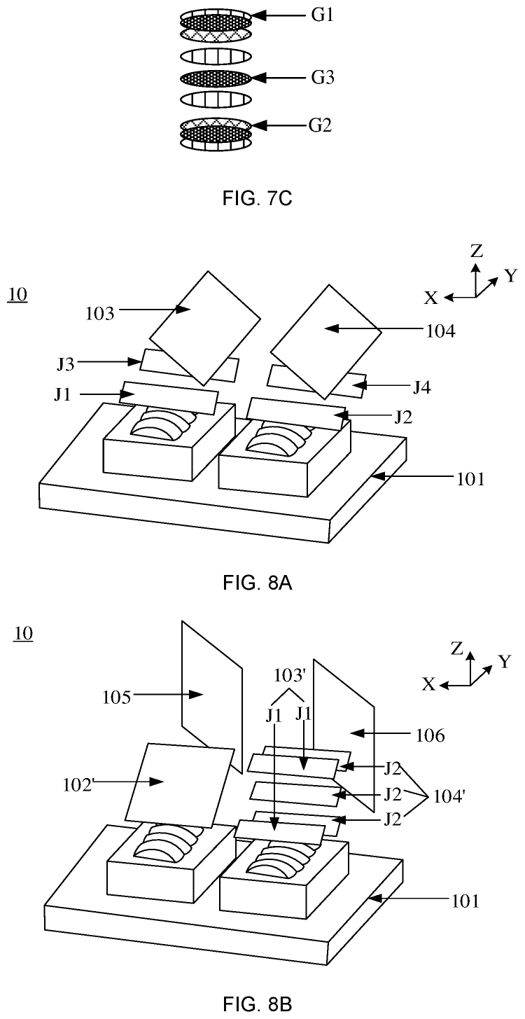

For example, FIG. 7A is a schematic diagram of beam spots formed by laser beams emitted by a projection laser source, in accordance with some embodiments of the present disclosure. The beam spots may be beam spots formed by the laser beams after the first combining lens 103 and the second combining lens 104 respectively emit the incident laser beams along the first direction. The beam spots G1 in FIG. 7A are beam spots formed by the laser beams from the first laser-exit region Q1, the beam spots G2 are beam spots formed by the laser beams from the second laser-exit region Q2, and the beam spots G3 are beam spots formed by the laser beams from the third laser-exit region Q3. As shown in FIG. 7A, in some embodiments of the present disclosure, the laser beams of the plurality of colors have good symmetry about the main optical axis of the projection laser source, and the distribution uniformity of the laser beams of the plurality of colors is high.

In some embodiments of the present disclosure, the laser beams emitted by the second laser-exit region Q2 is divided into two portions, and the two portions of the laser beams are respectively located at both sides of the laser beams emitted by the third laser-exit region Q3. On the second combining lens 104, the beam spots formed by the two portions of laser beams are respectively located on two sides of the beam spots formed by the laser beams emitted by the third laser-exit region Q3. In this way, compared with the related art, the symmetry of the second laser beam and the third laser beam may be made closer, so that the position of the symmetry axis of the second laser beam is proximate to the position of the symmetry axis of the third laser beam. For example, the center of the light beam formed by the second laser beam as a whole may be proximate to or coincide with the center of the light beam formed by the third laser beam as a whole. Furthermore, a difference in incident angles of the second laser beam and the third laser beam incident on the light homogenizing component may be reduced. In this way, it is conducive to improving the homogenization effect of the light homogenizing component on the second laser beam and the third laser beam and improving the light mixing effect of the second laser beam and the third laser beam.

Furthermore, when adjusting the second laser beam, the light guide lens group 102 further adjusts a portion of laser beam at an end of the first laser beam along the second direction to another end. In this way, the deviation between the irradiation position of the first laser beam in the first combining lens 103 and the irradiation position of the second laser beam and the third laser beam in the second combining lens 104 may be reduced. Therefore, after the first combining lens 103 and the second combining lens 104 respectively emit the incident laser beam along the first direction, the laser beams of the plurality of colors have good symmetry about the main optical axis of the projection laser source, and the symmetry centers of laser beams of different colors may be close to one another or coincided, which is conducive to improving the mixing effect of laser beams of the plurality of colors emitted by the projection laser source.

In the projection laser source provided by the above embodiments of the present disclosure, the light guide lens group may adjust the laser beam emitted by the first sub-region P1 at an end of the first laser-exit region Q1 and the laser beam emitted by the second sub-region P2 at a corresponding end of the second laser-exit region to transmit towards the first combining lens and the second combining lens respectively from the side of the third laser-exit region Q3 away from the second laser-exit region Q2. In this way, the laser beam from the second laser-exit region may be located on both sides of the laser beam emitted by the third laser-exit region when being emitted to the second combining lens, thereby improving the symmetry of the laser beam from the second laser-exit region and the laser beam from the third laser-exit region. In this way, it is conducive to improving the symmetry and uniformity of the laser beams of the plurality of colors after mixing through the first combining lens and the second combining lens, and further conducive to improving the display effect of the projection image formed based on the laser beams.

The light guide lens group 102 in some embodiments of the present disclosure will be described below with reference to the accompanying drawings.

With continued reference to FIGS. 3A, 4A, 5A, and 6A, the light guide lens group 102 may include a first light guide lens 1021 and a second light guide lens 1022 disposed along the second direction. An orthogonal projection of the first light guide lens 1021 on the laser device 101 covers the first sub-region P1 in the first laser-exit region Q1 and the second sub-region P2 in the second laser-exit region Q2. An orthogonal projection of the second light guide lens 1022 on the laser device 101 is located outside the third laser-exit region Q3 and is located at a side of the third laser-exit region Q3 away from the second laser-exit region Q2. The laser beams emitted by the first sub-region P1 and the second sub-region P2 may be emitted to the first light guide lens 1021. The first light guide lens 1021 is configured to reflect the incident laser beam to the second light guide lens 1022. The second light guide lens 1022 is configured to reflect the incident laser beam from the first sub-region P1 to the first combining lens 103 and reflect the incident laser beam from the second sub-region P2 to the second combining lens 104.

In some embodiments, with continued reference to FIGS. 3A to 6A, the first light guide lens 1021 and the second light guide lens 1022 are respectively integral lenses. Any one of the first light guide lens 1021 and the second light guide lens 1022 may be in a shape of a rectangle, and a length direction of the rectangle may be parallel to the first direction. The first light guide lens 1021 and the second light guide lens 1022 may be obliquely arranged, and the first light guide lens 1021 and the second light guide lens 1022 are parallel. The second light guide lens 1022 and the laser device 101 are located at a same side of the first light guide lens 1021, so that the first light guide lens 1021 may reflect the laser beam emitted by the laser device 101 towards the second light guide lens 1022.

The first light guide lens 1021, the first combining lens 103, and the second combining lens 104 are located on a same side of the second light guide lens 1022, so that the second light guide lens 1022 may reflect the laser beam emitted by the first light guide lens 1021 towards the first combining lens 103 and the second combining lens 104.

For example, an included angle between the first light guide lens 1021 and the second direction is 45 degrees, and an included angle between the second light guide lens 1022 and the second direction is 45 degrees. Furthermore, an included angle between the first light guide lens 1021 and the third direction is also 45 degrees, and an included angle between the second light guide lens 1022 and the third direction is also 45 degrees.

In some embodiments of the present disclosure, the sizes of the first light guide lens 1021 and the second light guide lens 1022 may be designed according to the size of the beam spots formed by the incident laser beams. A size of any one of the first light guide lens 1021 and the second light guide lens 1022 is greater than or equal to the size of the beam spots formed by the incident laser beams.

In some embodiments, the first light guide lens 1021 and the second light guide lens 1022 may have the same size and the same arrangement.

In some embodiments, an overall length of the beam spots formed on the first light guide lens 1021 by the laser beams emitted by the second sub-region P2 may be any value in a range from 2.5 mm to 3.5 mm, and an overall width may be any value in a range from 1.5 mm to 2.5 mm.

For example, the overall length of the beam spots formed by the laser beams emitted by the second sub-region P2 on the first light guide lens 1021 is 2.5 mm, 2.8 mm, 3.0 mm, or 3.5 mm, and the overall width is 1.5 mm, 1.8 mm, 2.0 mm, or 2.5 mm. For example, the overall size of the beam spots may be approximately 3 mm×2 mm.

For example, the size of the beam spot formed on the first light guide lens 1021 by the laser beam emitted by the first sub-region P1 is similar to the size of the beam spot formed on the first light guide lens 1021 by the laser beam emitted by the second sub-region P2.

In some embodiments, lengths of the first light guide lens 1021 and the second light guide lens 1022 are any value in a range from 9 mm to 10 mm, respectively, and widths are any value in a range from 1.5 mm to 3 mm, respectively.

For example, the lengths of the first light guide lens 1021 and the second light guide lens 1022 are 9 mm, 9.5 mm, or 10.0 mm, respectively, and the widths are 1.5 mm, 2 mm, 2.5 mm, or 3 mm, respectively. For example, the sizes of the first light guide lens 1021 and the second light guide lens 1022 may be 10 mm×2 mm, respectively.

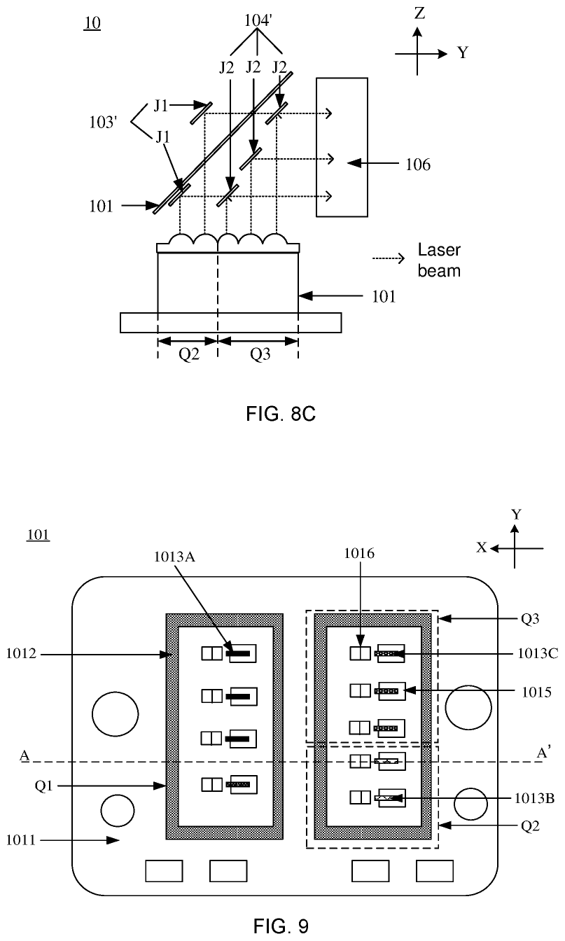

In some embodiments, the first light guide lens 1021 and the second light guide lens 1022 may include a plurality of individual lenses. FIG. 8A is a perspective view of a projection laser source provided with reflecting sub-regions, in accordance with some embodiments of the present disclosure. As shown in FIG. 8A, the first light guide lens 1021 includes a first reflecting sub-region J1 and a second reflecting sub-region J2, and the second light guide lens 1022 includes a third reflecting sub-region J3 and a fourth reflecting sub-region J4. An orthogonal projection of the first reflecting sub-region J1 on the laser device 101 covers the first sub-region P1, and an orthogonal projection of the second reflecting sub-region J2 on the laser device 101 covers the second sub-region P2. The first reflecting sub-region J1 and the third reflecting sub-region J3 may be disposed along the second direction, and the second reflecting sub-region J2 and the fourth reflecting sub-region J4 may also be disposed along the second direction.

For example, the first reflecting sub-region J1, the second reflecting sub-region J2, the third reflecting sub-region J3, and the fourth reflecting sub-region J4 may be reflective mirrors, respectively.

The first reflecting sub-region J1, the second reflecting sub-region J2, the third reflecting sub-region J3, and the fourth reflecting sub-region J4 may be obliquely arranged. For example, the four reflecting sub-regions may be parallel to each other.

The laser device 101 and the third reflecting sub-region J3 are located at a same side of the first reflecting sub-region J1, and the first reflecting sub-region J1 and the first combining lens 103 are located at a same side of the third reflecting sub-region J3. In this way, the laser beam emitted by the first sub-region P1 may be emitted towards the first reflecting sub-region J1. The first reflecting sub-region J1 is configured to reflect the incident laser beam towards the third reflecting sub-region J3, and the third reflecting sub-region J3 is configured to reflect the incident laser beam towards the first combining lens 103.

The laser device 101 and the fourth reflecting sub-region J4 are located at a same side of the second reflecting sub-region J2, and the second reflecting sub-region J2 and the second combining lens 104 are located at a same side of the fourth reflecting sub-region J4. In this way, the laser beam emitted by the second sub-region P2 may be emitted towards the second reflecting sub-region J2. The second reflecting sub-region J2 is configured to emit the incident laser beam towards the fourth reflecting sub-region J4, and the fourth reflecting sub-region J4 is configured to reflect the incident laser beam towards the second combining lens 104.

For example, included angles between the first reflecting sub-region J1 and the second direction, between the second reflecting sub-region J2 and the second direction, between the third reflecting sub-region J3 and the second direction, and between the fourth reflecting sub-region J4 and the second direction may be 45 degrees, and included angles between the first reflecting sub-region J1 and the third direction, between the second reflecting sub-region J2 and the third direction, between the third reflecting sub-region J3 and the third direction, and between the fourth reflecting sub-region J4 and the third direction may be 45 degrees.

In some embodiments of the present disclosure, the size of any one of the reflecting sub-regions may be determined according to the size of the beam spots formed by the incident laser beam.

In some embodiments, the first reflecting sub-region J1, the second reflecting sub-region J2, the third reflecting sub-region J3, and the fourth reflecting sub-region J4 may have the same size and the same arrangement.

For example, any one of the four reflecting sub-regions are in a shape of a rectangle, and a length direction of the rectangle may be parallel to the first direction.

In some embodiments, a length of any one of the first reflecting sub-region J1, the second reflecting sub-region J2, the third reflecting sub-region J3, and the fourth reflecting sub-region J4 is any value in a range from 2.5 mm to 4 mm, and the width is any value in a range from 1.5 mm to 3 mm.

For example, the length of the any one of the first reflecting sub-region J1, the second reflecting sub-region J2, the third reflecting sub-region J3, and the fourth reflecting sub-region J4 is 2.5 mm, 3.0 mm, 3.5 mm, or 4 mm, and the length of the any one of the first reflecting sub-region J1, the second reflecting sub-region J2, the third reflecting sub-region J3, and the fourth reflecting sub-region J4 is 1.5 mm, 2.0 mm, 2.5 mm, or 3 mm. For example, the size of the any one of the first reflecting sub-region J1, the second reflecting sub-region J2, the third reflecting sub-region J3, and the fourth reflecting sub-region J4 may be approximately 3 mm×2 mm.

In some embodiments, the size of the beam spots formed by the laser beam emitted by the first sub-region P1 may be different from the size of the beam spots formed by the laser beam emitted by the second sub-region P2, and thus the sizes of the first reflecting sub-region J1 and the second reflecting sub-region J2 may be different. Since the laser beam received by the third reflecting sub-region J3 is the laser beam emitted by the first reflecting sub-region J1, and the laser beam received by the fourth reflecting sub-region J4 is the laser beam emitted by the second reflecting sub-region J2, the sizes of the first reflecting sub-region J1 and the third reflecting sub-region J3 may be the same, and the sizes of the second reflecting sub-region J2 and the fourth reflecting sub-region J4 may be the same.

In some embodiments of the present disclosure, the light guide lens may be a reflector. The light guide lens can be made of metal material or may be obtained by coating a reflective film on a transparent lens. In some embodiments, the light guide lens may also be a dichroic mirror. In this case, the light guide lens may emit the incident laser beam in a desired direction. Some embodiments of the present disclosure do not limit the transmittance of the light guide lens to laser beams of other colors.

FIG. 3B is a perspective view of another projection laser source, in accordance with some embodiments of the present disclosure. FIG. 4B is a side view of another projection laser source, in accordance with some embodiments of the present disclosure. FIG. 5B is a top view of another projection laser source, in accordance with some embodiments of the present disclosure. FIG. 4B may be a right view of the projection laser source shown in FIG. 3B, and FIG. 5B may be a top view of the projection laser source shown in FIG. 3B.

Some embodiments of the present disclosure further provide another projection laser source, as shown in FIGS. 3B to 5B, the projection laser source 10 may include a laser device 101, and a sixth combining lens 102′, a seventh combining lens 103′, a third combining lens 104′, a fourth combining lens 105, and a fifth combining lens 106 located on the laser-exit side of the laser device 101.

The laser device 101 is configured to emit laser beams along the third direction (e.g., the Z direction). The laser device 101 may include a first laser-exit region Q1, a second laser-exit region Q2, and a third laser-exit region Q3, each laser-exit region is configured to emit laser beams of one color, and laser beams emitted by different laser-exit regions have different colors. The second laser-exit region Q2 and the third laser-exit region Q3 are located at a same side of the first laser-exit region Q1 in the first direction (e.g., the X direction). The second laser-exit region Q2 and the third laser-exit region Q3 are disposed along the second direction (e.g., Y direction), the first direction is perpendicular to the second direction, and the first direction and the second direction are perpendicular to the third direction.

In some embodiments, the first laser-exit region Q1 may be in a shape of a rectangle. The first direction may be a length direction of the rectangle, and the second direction may be a width direction of the rectangle.

As shown in FIGS. 3B and 5B, the second laser-exit region Q2 and the third laser-exit region Q3 are located at the right side of the first laser-exit region Q1. The second laser-exit region Q2 and the first laser-exit region Q1 are disposed along the X direction, and the third laser-exit region Q3 and the first laser-exit region Q1 are disposed along the X direction.

In some embodiments, the second laser-exit region Q2 and the third laser-exit region Q3 may also be located at the left side of the first laser-exit region Q1. The second laser-exit region Q2 and the first laser-exit region Q1 are disposed in the opposite direction of the X direction, and the third laser-exit region Q3 and the first laser-exit region Q1 may also be disposed in the opposite direction of the X direction.

In some embodiments, in FIGS. 3B and 5B, the positions of the second laser-exit region Q2 and the third laser-exit region Q3 may also be interchanged, and accordingly, the second direction may be the opposite direction of the Y direction.

The sixth combining lens 102′, the seventh combining lens 103′, and the third combining lens 104′ may correspond to the first laser-exit region Q1, the second laser-exit region Q2, and the second laser-exit region Q2, respectively. An orthogonal projection of any one of the three combining lenses on the laser device 101 may cover the corresponding laser-exit region. The positional relationship of the three combining lenses may refer to the above introduction to the positional relationship of the three laser-exit regions.

For example, an orthogonal projection of the sixth combining lens 102′ on the laser device 101 may cover the first laser-exit region Q1, an orthogonal projection of the seventh combining lens 103′ on the laser device 101 may cover the second laser-exit region Q2, and an orthogonal projection of the third combining lens 103′ on the laser device 101 may cover the third laser-exit region Q3. Any one of the first laser-exit region Q1, the second laser-exit region Q2, and the third laser-exit region Q3 is configured to emit a laser beam towards a corresponding combining lens. For example, the first laser-exit region Q1 is configured to emit a laser beam towards the sixth combining lens 102′, the second laser-exit region Q2 is configured to emit a laser beam towards the seventh combining lens 103′, and the second laser-exit region Q2 is configured to emit a laser beam towards the third combining lens 104′.

In some embodiments of the present disclosure, the sixth combining lens 102′ and the fourth combining lens 105 are disposed along the second direction, and the seventh combining lens 103′, the third combining lens 104′, and the fifth combining lens 106 are also disposed along the second direction. On a reference plane perpendicular to the second direction, orthogonal projections of the sixth combining lens 102′ and the fourth combining lens 105 at least partially overlap, and orthogonal projections of the seventh combining lens 103′, the third combining lens 104′, and the fifth combining lens 106 at least partially overlap.

It will be noted that the reference plane described in some embodiments of the present disclosure is only an imaginary plane used to describe the position and size relationship between the plurality of components and may not be a plane that actually exists in the projection laser source.

The sixth combining lens 102′, the seventh combining lens 103′, the third combining lens 104′, the fourth combining lens 105, and the fifth combining lens 106 may be obliquely arranged.

The laser device 101 and the fourth combining lens 105 may be located on a same side of the sixth combining lens 102′, and the sixth combining lens 102′ is configured to reflect the laser beam emitted by the first laser-exit region Q1 in the laser device 101 towards the fourth combining lens 105 along the second direction.

The laser device 101 and the third combining lens 104′ are located at a same side of the seventh combining lens 103′, and the seventh combining lens 103′ is configured to reflect the laser beam emitted by the second laser-exit region Q2 in the laser device 101 towards the third combining lens 104′ along the second direction.

The laser device 101 and the fifth combining lens 106 are located at a same side of the third combining lens 104′. The third combining lens 104′ may be a dichroic mirror. The third combining lens 104′ is configured to reflect the laser beam emitted by the third laser-exit region Q3 in the laser device 101 along the second direction towards the fifth combining lens 106. The third combining lens 104′ may further transmit the laser beam reflected by the seventh combining lens 103′ towards the fifth combining lens 106 along the second direction. In this way, after passing through the third combining lens 104′, the mixing of the laser beam emitted by the second laser-exit region Q2 and the laser beam emitted by the third laser-exit region Q3 may be implemented.

Some embodiments of the present disclosure take the X direction as the first direction as an example, and the fifth combining lens 106 and the fourth combining lens 105 may be disposed along the X direction. On the reference plane perpendicular to the first direction, an orthogonal projection of the fifth combining lens 106 at least partially overlaps with an orthogonal projection of the fourth combining lens 105. The fifth combining lens 106 and the fourth combining lens 105 may be obliquely arranged. The fourth combining lens 105 and the third combining lens 104′ may be located at a same side of the fifth combining lens 106. The fifth combining lens 106 may reflect the laser beam emitted by the third combining lens 104′ towards the fourth combining lens 105 along the X direction. The fourth combining lens 105 is a dichroic mirror. The fourth combining lens 105 may transmit the laser beam reflected by the fifth combining lens 106 along the X direction, and the fourth combining lens 105 may further reflect the laser beam reflected by the sixth combining lens 102′ along the X direction.

In some embodiments, the first direction may be the opposite direction of the X direction. The fifth combining lens 106 and the fourth combining lens 105 may still be disposed along the X direction. In this case, the oblique directions of the fifth combining lens 106 and the fourth combining lens 105 may be adjusted to implement the mixing of the above laser beams. For example, the fifth combining lens 106 and the fourth combining lens 105 are rotated 90 degrees in a plane where the X direction and the Y direction are located, and the fifth combining lens 106 may be a dichroic mirror. For example, the above-mentioned mixing of the laser beams may be implemented by rotating the fifth combining lens 106 counterclockwise by 90 degrees with a straight line passing through the fifth combining lens 106 and parallel to the Z direction as a rotation axis and by rotating the fourth combining lens 105 counterclockwise by 90 degrees with a straight line passing through the fourth combining lens 105 and parallel to the Z direction as a rotation axis.

FIG. 6B is a top view of yet another projection laser source, in accordance with some embodiments of the present disclosure. As shown in FIG. 6B, the fourth combining lens 105 may reflect the laser beam towards the fifth combining lens 106, and the laser beam may be emitted in the opposite direction of the X direction through the fifth combining lens 106. Furthermore, the fifth combining lens 106 may reflect the laser beam emitted by the third combining lens 104′ along the opposite direction of the X direction.

For example, FIG. 7B is a schematic diagram of beam spots formed by laser beams emitted by another projection laser source, in accordance with some embodiments of the present disclosure. The beam spots may be beam spots formed by laser beams after the fifth combining lens 106 and the fourth combining lens 105 emit the incident laser beam along the first direction. The beam spots G1 in FIG. 7B are beam spots formed by the laser beams from the first laser-exit region Q1, the beam spots G2 are beam spots formed by the laser beams from the second laser-exit region Q2, and the beam spots G3 are beam spots formed by the laser beams from the third laser-exit region Q3. As shown in FIG. 7B, in some embodiments of the present disclosure, the laser beams of the plurality of colors have good symmetry about the main optical axis of the projection laser source, and the distribution uniformity of laser beams of the plurality of colors is high.

In some embodiments of the present disclosure, for the second laser-exit region Q2 and the third laser-exit region Q3 disposed along the second direction, the laser beam emitted by the second laser-exit region Q2 (abbreviated as the second laser beam) and the laser beam emitted by the third laser-exit region Q3 (abbreviated as the third laser beam) are first combined in the second direction through the seventh combining lens 103′ and the third combining lens 104′, which is conducive to improving the center overlap degree of the second laser beam and the third laser beam. Afterwards, the mixed second laser beam and the third laser beam are remixed with the laser beam emitted by the first laser-exit region Q1 through the sixth combining lens 102′, the fourth combining lens 105, and the fifth combining lens 106, and the remixed laser beam may be emitted along the first direction, which is conducive to improving the symmetry of the three laser beams about the main optical axis of the projection laser source, and is conducive to improving the distribution uniformity of laser beams of the plurality of colors, thereby improving the light mixing effect.

In some embodiments of the present disclosure, the sixth combining lens 102′ and the seventh combining lens 103′ may be full-band reflectors or may be dichroic mirrors. In some embodiments of the present disclosure, in the third direction, a distance between the sixth combining lens 102′ and the laser device 101, a distance between the seventh combining lens 103′ and the laser device 101, and a distance between the third combining lens 104′ and the laser device 101 may be equal. The distance may refer to a distance between a center position of the combining lens and the laser device 101.

In summary, in the projection laser source provided by some embodiments of the present disclosure, the laser beams emitted by the second laser-exit region Q2 and the third laser-exit region Q3 disposed along the second direction may be combined in the second direction by the seventh combining lens 103′ and the third combining lens 104′, thereby improving the symmetry of the laser beam from the second laser-exit region and the laser beam from the third laser-exit region. Afterwards, the laser beams of the plurality of colors emitted by the laser beam are mixed and emitted along the first direction through the sixth combining lens 102′, the fourth combining lens 105, and the fifth combining lens 106, thereby improving the symmetry and uniformity of the laser beams of the plurality of colors emitted by the projection laser source and improving the display effect of the projection image formed based on the laser beams.

In some embodiments, with continued reference to FIGS. 3B, 4B, 5B, and 6B, the sixth combining lens 102′, the seventh combining lens 103′, the third combining lens 104′, the fourth combining lens 105, and the fifth combining lens 106 are respectively integral lenses. The sixth combining lens 102′, the seventh combining lens 103′, and the third combining lens 104′ may be parallel to each other. Included angles between the three combining lenses and the second direction may be 45 degrees, respectively, and included angles between the three combining lenses and the third direction may also be 45 degrees, respectively.

Since distances between adjacent chips in the second laser-exit region Q2 in the laser device 101 are equal, and distances between adjacent chips in the third laser-exit region Q3 in the laser device 101 are equal, after reflection by the seventh combining lens 103′ and the third combining lens 104′, distances between the plurality of small beam spots formed by the second laser beam are equal, and distances between the plurality of small beam spots formed by the third laser beam are also equal. As shown in FIG. 7B, the second laser-exit region Q2 may include two light-emitting chips, and the second laser beams emitted by the second laser-exit region Q2 may form two small beam spots. The third laser-exit region Q3 may include three light-emitting chips, and the third laser beams emitted by the third laser-exit region Q3 may form three small beam spots. The two small beam spots and the three small beam spots may be disposed alternately.

FIG. 8B is a perspective view of another projection laser source provided with reflecting sub-regions, in accordance with some embodiments of the present disclosure, and FIG. 8C is a side view of another projection laser source provided with reflecting sub-regions, in accordance with some embodiments of the present disclosure. FIG. 8C may be a right side view of the projection laser source shown in FIG. 8B.

As shown in FIG. 8B, the seventh combining lens 103′ may include a plurality of first reflecting sub-regions J1 disposed along the second direction, and different first reflecting sub-regions J1 are at different distances from the laser device 101. The third combining lens 104′ includes a plurality of second reflecting sub-regions J2 disposed along the second direction, and different second reflecting sub-regions J2 are at different distances from the laser device 101.

Some embodiments of the present disclosure are described by taking the seventh combining lens 103′ including two first reflecting sub-regions J1 and the third combining lens 103′ including three second reflecting sub-regions J2 as an example. By dividing the seventh combining lens 103′ and the third combining lens 103′ into a plurality of reflecting sub-regions, it is convenient to adjust the position of the laser beam emitted by the second laser-exit region Q2 and the position of the laser beam emitted by the third laser-exit region Q3.

For example, orthogonal projections of the first reflecting sub-region J1 and the second reflecting sub-region J2 proximate to the laser device 101 on the fifth combining lens 106 at least partially overlap, and orthogonal projections of the first reflecting sub-region J1 and the second reflecting sub-region J2 far from the laser device 101 on the fifth combining lens 106 at least partially overlap. In this way, the laser beams emitted by the first reflecting sub-region J1 and the second reflecting sub-region J2 proximate to the laser device 101 are coincided, and the laser beams emitted by the first reflecting sub-region J1 and the second reflecting sub-region J2 far from the laser device 101 also are coincided, which is conducive to reducing the overall range difference of the beam spots formed by the laser beam from the second laser-exit region Q2 and the laser beam from the third laser-exit region Q3 and is conducive to improving the symmetry of the two laser beams.

In some embodiments, the height of the plurality of reflecting sub-regions may be further designed, so that an edge of the beam spots formed by the laser beam from the second laser-exit region Q2 and the laser beam from the third laser-exit region Q3 is proximate to an edge of the beam spots formed by the laser beam from the first laser-exit region Q1. For example, distances between the first reflecting sub-region J1 and the second reflecting sub-region J2 proximate to the laser device 101 and the laser device 101 may be equal to distances between the laser device 101 and a small beam spot closest to the laser device 101 on the sixth combining lens 102′. Or, distances between the first reflecting sub-region J1 and the second reflecting sub-region J2 far away from the laser device 101 and the laser device 101 may be equal to distances between the laser device 101 and a small beam spot farthest to the laser device 101 on the sixth combining lens 102′.

For example, FIG. 7C is a schematic diagram of beam spots formed by laser beams emitted by yet another projection laser source, in accordance with some embodiments of the present disclosure. As shown in FIG. 7C, sizes of the beam spot G2 formed by the laser beam from the second laser-exit region Q2 and the beam spot G3 formed by the laser beam from the third laser-exit region Q3 are similar to a size of the beam spot G1 formed by the laser beam from the first laser-exit region Q1. The laser beams of the plurality of colors have good symmetry about the main optical axis of the projection laser source, and the distribution uniformity of the laser beams of the plurality of colors is high. The edges of the beam spot G1, the beam spot G2 and the beam spot G3 have a high degree of fit. In a case where the laser beams distributed in this way pass through the light homogenizing component, the homogenization effect in the light homogenizing component is highly consistent and has a good homogenization effect, thereby further improving the display effect of the projection image formed based on the laser beam.

In some embodiments of the present disclosure, a size of any one of the plurality of reflecting sub-regions may be determined according to the size of the beam spot formed by the incident laser beam.

In some embodiments, the first reflecting sub-region J1 and the second reflecting sub-region J2 may have the same size and the same arrangement. For example, the first reflecting sub-region J1 and the second reflecting sub-region J2 are in a shape of a rectangle, and a length direction of the rectangle may be parallel to the first direction.

In some embodiments, a length of any one of the plurality of reflecting sub-regions may be any value in a range from 2.5 mm to 4 mm, and a width may be any value in a range from 1.5 mm to 3 mm. For example, the length of any one of the plurality of reflecting sub-regions may be 2.5 mm, 3.0 mm, 3.5 mm, or 4 mm, and the width may be 1.5 mm, 2.0 mm, 2.5 mm, or 3 mm. For example, the size of the any one of the plurality of reflecting sub-regions may be approximately 3 mm×2 mm.

Some embodiments of the present disclosure are described by taking the seventh combining lens 103′ and the third combining lens 104′ as examples, in which the seventh combining lens 103′ and the third combining lens 104′ are divided into a plurality of reflecting sub-regions, respectively.

In some embodiments, one of the seventh combining lens 103′ and the third combining lens 104′ is divided into a plurality of reflecting sub-regions.

In some embodiments, the first combining lens 102′ is divided into a plurality of reflecting sub-regions, and the division method of the reflecting sub-regions of the first combining lens 102′ may be the same as that of the seventh combining lens 103′ and the third combining lens 104′, which will not be repeated here.

The laser device 101 in some embodiments of the present disclosure will be described below with reference to the accompanying drawings.

The laser device 101 in some embodiments of the present disclosure may be a multi-color laser device. The multi-color laser device is a laser device that may emit laser beams of a plurality of colors.

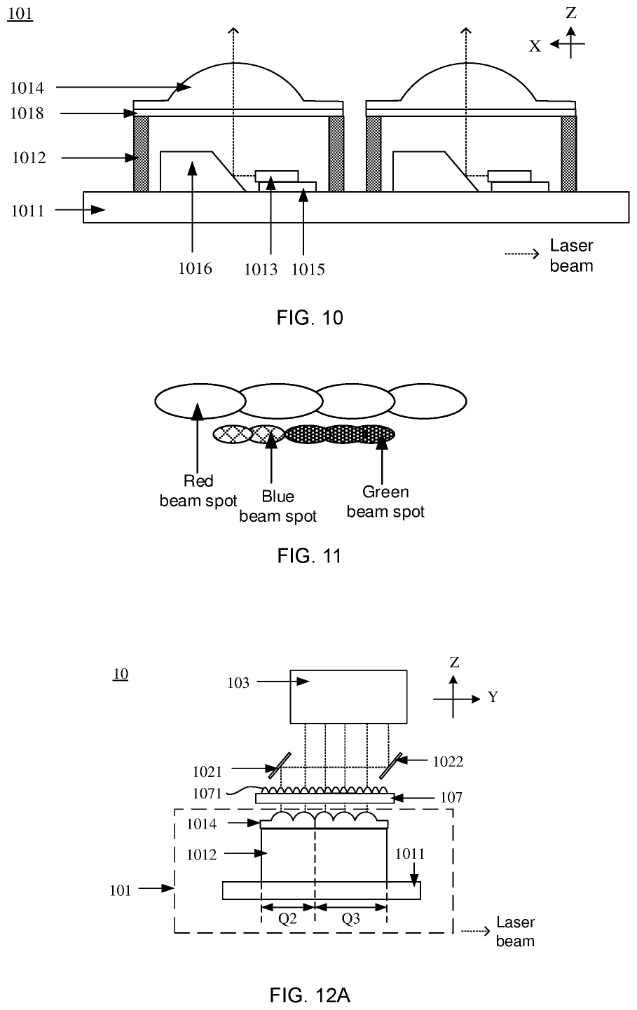

FIG. 9 is a structural diagram of a laser device, in accordance with some embodiments of the present disclosure. FIG. 10 is a cross-sectional view taken along a line A-A′ in FIG. 9. FIG. 10 may be a top view of the laser device as shown in FIG. 9.

With reference to FIGS. 3A to 10, the laser device 101 may include a bottom plate 1011 and two light-emitting modules. An orthogonal projection of any device (e.g., the light guide lens or the combining lens) described in some embodiments of the present disclosure on the laser device 101 may refer to an orthogonal projection of the device on the bottom plate 1011 of the laser device 101.

The two light-emitting modules are located on the bottom plate 1011, and the two light-emitting modules may be disposed along a first direction. One of the two light-emitting modules may include an annular tube wall 1012 and a plurality of light-emitting chips 1013 surrounded by the tube wall 1012. In some embodiments, any of the two light-emitting modules may be in the shape of a long strip, and an orthogonal projection of any of the two light-emitting modules on the bottom plate 1011 may be approximately in the shape of a rectangle. A length direction of the rectangle may be parallel to the second direction, and a width direction may be parallel to the first direction.

As shown in FIG. 9, a plurality of light-emitting chips 1013 in any of the two light-emitting modules may be arranged in at least one row along the first direction. Some embodiments of the present disclosure are described by taking the plurality of light-emitting chips being disposed in only one row as an example.

In some embodiments, the plurality of light-emitting chips may also be disposed in a plurality of rows, such as two rows or three rows, which is not limited in the present disclosure.

In some embodiments, slow axes of laser beams emitted by the plurality of light-emitting chips 1013 in any one of the two light-emitting modules may be parallel to the first direction.

It will be noted that transmission speeds of the laser beam in different light vector directions are different. A light vector direction with fast transmission speed is a fast axis direction of the laser beam, and a light vector direction with slow transmission speed is a slow axis direction of the laser beam. The fast axis direction is perpendicular to the slow axis direction.

For example, the fast axis direction may be perpendicular to a surface of the light-emitting chip 1013, and the slow axis direction may be parallel to the surface of the light-emitting chip 1013. For example, the fast axis direction is the Z direction, and the slow axis direction is the Y direction.

The divergence angle of the laser beam in the fast axis direction is larger than the divergence angle of the laser beam in the slow axis direction. For example, the divergence angle of the laser beam in the fast axis direction is generally more than three times the divergence angle in the slow axis direction. The light-emitting chips 1013 are disposed with the slow axis direction of the emitted laser beam as the arrangement direction. Since the divergence angle of the laser beam in this direction is small, the distance between adjacent light-emitting chips 1013 may be reduced while avoiding interference and overlap of laser beams emitted by the adjacent light-emitting chips 1013, thereby facilitating the increase of the arrangement density of the light-emitting chips 1013 and miniaturization of the laser device.

In some embodiments, the plurality of light-emitting chips 1013 in the light-emitting module may also be arranged in an array, for example, the plurality of light-emitting chips 1013 are arranged in a plurality of rows and columns.

Any one of the two light-emitting modules may further include a collimating lens group 1014, a plurality of heat sinks 1015, a plurality of reflective prisms 1016, and a light-transmitting sealing layer 1018. The plurality of heat sinks 1015 and the plurality of reflective prisms 1016 may correspond to the plurality of light-emitting chips 1013 in the light-emitting module, respectively. Any one of the plurality of light-emitting chips 1013 is located on a corresponding heat sink 1015. The heat sink 1015 is configured to assist the corresponding light-emitting chip 1013 in dissipating heat. For example, the material of the heat sink 1015 may include ceramics.

One of the plurality of reflective prism 1016 is located on a laser-exit side of the corresponding light-emitting chip 1013. The light-transmitting sealing layer 1018 is located at a side of the tube wall 1012 away from the bottom plate 1011 and is configured to seal an opening of the tube wall 1012 away from the bottom plate 1011, so as to enclose a sealed space together with the bottom plate 1011 and the tube wall 1012.

In some embodiments, the laser device 101 may not include the light-transmitting sealing layer 1018. The collimating lens group 1014 may be directly fixed to the surface of the tube wall 1012 away from the bottom plate 1011. In this case, the collimating lens group 1014, the tube wall 1012, and the bottom plate 1011 together form a sealed space.

In this case, the collimating lens group 1014 is located at a side of the cover plate 1018 away from the bottom plate 1011. The collimating lens group 1014 includes a plurality of collimating lenses corresponding to the plurality of light-emitting chips 1013.

In some embodiments of the present disclosure, the plurality of collimating lenses in each collimating lens group 1014 may be integrally formed. For example, the collimating lens group 1014 is substantially plate-shaped. A surface of the collimating lens group 1014 proximate to the bottom plate 1011 is a plane, and a surface of the collimating lens group 1014 away from the bottom plate 1011 is provided with a plurality of convex curved surfaces. The portion where any one of the plurality of convex curved surfaces is located constitutes a collimating lens.

The light-emitting chip 1013 may emit a laser beam to a corresponding reflective prism 1016, and the reflective prism 1016 may reflect the laser beam to a collimating lens corresponding to the light-emitting chip 1013 in the collimating lens group 1014 along a direction away from the bottom plate 1011 (e.g., the Z direction), so that the laser beam may be collimated by the collimating lens and then emitted.

It will be noted that, after the laser beam emitted by the light-emitting chip 1013 is adjusted by the collimating lens, the divergence angle of the laser beam in the fast axis direction may be less than the divergence angle of the laser beam in the slow axis direction.

In some embodiments of the present disclosure, the light-emitting chips 1013 in different light-emitting modules of the laser device 101 may be configured to emit laser beams of different colors.

It will be noted that the light-emitting chips may be divided according to the color of the light emitted. Each type of light-emitting chip may emit a laser beam of one color, and different types of light-emitting chips are configured to emit laser beams of different colors.

In some embodiments of the present disclosure, different light-emitting modules in the laser device 101 may include different types of light-emitting chips. Any one of the light-emitting modules may include only one type of light-emitting chip, or any one of the light-emitting modules may include a plurality of types of light-emitting chips.

For example, as shown in FIGS. 9 and 10, the laser device 101 may include a first light-emitting module and a second light-emitting module. The first light-emitting module may be a light-emitting module on the left side in FIG. 9, and the second light-emitting module may be a light-emitting module on the right side in FIG. 9. The first light-emitting module may include a plurality of first type light-emitting chips 1013A, and the second light-emitting module may include a plurality of second type light-emitting chips 1013B and a plurality of third type light-emitting chips 1013C. Wavelengths of laser beams emitted by the first type light-emitting chip 1013A, the second type light-emitting chip 1013B, and the third type light-emitting chip 1013C are decreased in sequence.

For example, the first type light-emitting chip 1013A is configured to emit the red laser beam, the second type light-emitting chip 1013B is configured to emit the blue laser beam, and the third type light-emitting chip 1013C is configured to emit the green laser beam. For example, the first laser beam is the red laser beam, the second laser beam is the blue laser beam, and the third color laser beam is the green laser beam.

In some embodiments, the laser beams emitted by the three types of light-emitting chips may further be other colors. For example, the third type light-emitting chip 1013C is configured to emit the yellow laser beam.

It will be noted that some embodiments of the present disclosure are illustrated by taking an example that the first light-emitting module includes four first type light-emitting chips 1013A, and the second light-emitting module includes three second type light-emitting chips 1013B and two third type light-emitting chips 1013C. The quantity of the three types of light-emitting chips may also be adjusted according to demand. For example, the first light-emitting module includes five or other numbers of first type light-emitting chips 1013A, and the second light-emitting module includes four or other numbers of second type light-emitting chips 1013B and three or other numbers of third type light-emitting chips 1013C.

In some embodiments of the present disclosure, the first laser-exit region Q1 of the laser device 101 may be a region where the first light-emitting module is located, the second laser-exit region Q2 may be a region where the second type of light-emitting chips 1013B in the second light-emitting module are located, and the third laser-exit region Q3 may be a region where the third type of light-emitting chips 1013C in the second light-emitting module are located. The first sub-region P1 in the first laser-exit region Q1 may be a region where a portion of the first type light-emitting chips 1013A located at an end of the first light-emitting module are located. The second sub-region P2 in the second laser-exit region Q2 may be a region where a portion of the second type light-emitting chips 1013B located at an end of the second light-emitting module are located.

In some embodiments, the second sub-region P2 may be a half area of the second laser-exit region Q2, or the second sub-region P2 may be slightly greater or less than a half area of the second laser-exit region Q2. A size of the first sub-region P1 may be set based on a size of the second sub-region P2.

In this way, the second laser beam emitted by the second laser-exit region Q2 may be divided into two portions, so that the two portions of laser beam are respectively located on both sides of the third laser beam when being emitted to the second combining lens 104, thereby improving the symmetry of the second laser beam.

For example, in some embodiments of the present disclosure, two second type light-emitting chips 1013B are disposed in the second laser-exit region Q2, and the second sub-region P2 may be a region where one of the two second type light-emitting chips 1013B away from the third type light-emitting chip 1013C is located. Correspondingly, the first sub-region P1 may be a region where a first type light-emitting chip 1013A is located. The sizes of the first sub-region P1 and the second sub-region P2 may also be adjusted according to the number and arrangement of the types of light-emitting chips.

In some embodiments, the laser device 101 may also include only one tube wall 1012, such as the laser beam shown in FIG. 1. The plurality of light-emitting chips 1013 in the laser device 101 may be arranged in a plurality of rows and columns on the single tube wall 1012. The arrangement of the plurality of light-emitting chips 1013 may be the same as the arrangement of the light-emitting chips 1013 in FIG. 9 and FIG. 10, and details will not be repeated herein. In this type of laser device 101, the plurality of laser-exit regions are regions where the plurality of types of light-emitting chips are located.

In some embodiments, referring to FIG. 8B, the plurality of first reflecting sub-regions J1 in the seventh combining lens 103′ may correspond to the plurality of columns of second type light-emitting chips 1013B in the second laser-exit region Q2. Any one of the plurality of first reflecting sub-regions J1 is located at a laser-exit side of a corresponding column of second type light-emitting chips 1013B, and the laser beam emitted by the column of second type light-emitting chips 1013B is emitted towards the first reflecting sub-region J1. Any one of the plurality of first reflecting sub-regions J1 is configured to reflect the laser beam emitted by the corresponding column of second type light-emitting chips 1013B along the second direction.

In some embodiments of the present disclosure, the second laser-exit region Q2 includes a row of second type light-emitting chips 1013B, and any one of the plurality of first reflecting sub-regions J1 corresponds to a second type light-emitting chip 1013B. The any one of the plurality of first reflecting sub-regions J1 first reflecting sub-region J1 in the seventh combining lens 103′ reflects the laser beam emitted by a corresponding second type light-emitting chip 1013B along the second direction.

The plurality of second reflecting sub-regions J2 in the third combining lens 104′ may correspond to the plurality of columns of third type light-emitting chips 1013C. Any one of the plurality of second reflecting sub-regions J2 is located on the laser-exit side of a corresponding column of third type light-emitting chips 1013C. The laser beam emitted by the column of the third type light-emitting chips 1013C is emitted towards the second reflecting sub-region J2. Any one of the plurality of second reflecting sub-regions J2 is configured to reflect the laser beam emitted by the corresponding column of the third type light-emitting chips 1013C along the second direction.

In some embodiments of the present disclosure, the third laser-exit region Q3 includes a row of third type light-emitting chips 1013C, and any one of the plurality of second reflecting sub-regions J2 corresponds to a third type light-emitting chip 1013C. The any one of the plurality of second reflecting sub-regions J2 in the third combining lens 104′ reflects the laser beam emitted by a corresponding third type light-emitting chip 1013C along the second direction.

The laser beam reflected by the first reflecting sub-region J1 may be emitted towards the second reflecting sub-region J2, and the second reflecting sub-region J2 may be a dichroic mirror, which is configured to transmit the laser beam reflected by the first reflecting sub-region J1. The first reflecting sub-region J1 may be a reflector for the entire wavelength range or may also be a dichroic mirror. In a case where the first reflecting sub-region J1 is a dichroic mirror, the first reflecting sub-region J1 may reflect the laser beam emitted by the first laser-exit region Q1.

It will be noted that the divergence angle of the red laser beam emitted by the laser device is greater than the divergence angles of the green laser beam and the blue laser beam. That is, the divergence angle of the laser beam emitted by the first laser-exit region Q1 of the laser device 101 is greater than the divergence angles of the laser beams emitted by the second laser-exit region Q2 and the third laser-exit region Q3. In a case where the laser beams of the plurality of colors are transmitted according to the divergence angles, the difference between the spot area of the red laser beam and the spot areas of the green laser beam and the blue laser beam will become increasingly greater.

FIG. 11 is a schematic diagram of beam spots formed by laser beams emitted by a projection laser source, in accordance with the related art. As shown in FIG. 11, in the related art, the area of the red beam spot is much greater than the area of the green beam spot and the area of the red beam spot, which results in a poor mixing effect of the laser beams of different colors and is not conducive to the formation of a projection image.

Some embodiments of the present disclosure may further be improved based on the above-mentioned projection laser source, so as to reduce the difference between the divergence angles of the laser beams of different colors emitted by the projection laser source. In this way, the light mixing effect of the laser beams of different colors may be further improved, and the display effect of the projection image formed based on the laser beams may be further improved.

In some embodiments of the present disclosure, a component for adjusting the divergence angle of the laser beam may be disposed between the laser device 101 and the combining lens to which the laser beam emitted by the laser beam is emitted, so that the divergence angles of laser beams of different colors emitted to the combining lens may be closed, thereby improving the consistency of the beam spots of the laser beams of different colors after light combining during the transmission process.

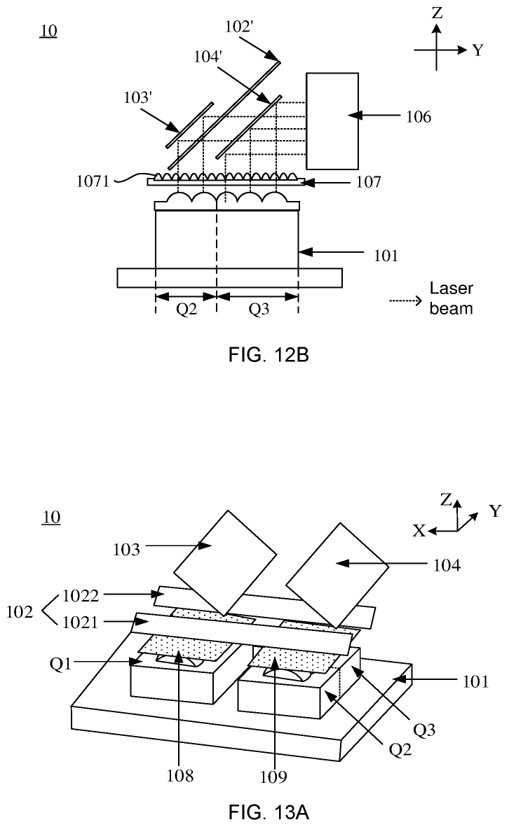

FIG. 12A is a side view of a projection laser source provided with a fly-eye lens, in accordance with some embodiments of the present disclosure.

In some embodiments, as shown in FIG. 12A, the projection laser source 10 may further include a first fly-eye lens 107. The first fly-eye lens 107 may be located between the laser device 101 and the combining lenses (i.e., the first combining lens 103 and the second combining lens 104). An orthogonal projection of the first fly-eye lens 107 on the laser device 101 covers the first laser-exit region Q1, the second laser-exit region Q2, and the third laser-exit region Q3. The laser beam emitted by the laser device 101 may be homogenized by the first fly-eye lens 107 and then emitted to the first combining lens 103 and the second combining lens 104. For example, the laser beam emitted by the first laser-exit region Q1 is homogenized by the first fly-eye lens 107 and then emitted to the first combining lens 103. The laser beams emitted by the second laser-exit region Q2 and the third laser-exit region Q3 are homogenized by the first fly-eye lens 107 and then emitted to the second combining lens 104.

It will be noted that FIG. 12A illustrates by taking an example in which the first fly-eye lens 107 is located between the laser device 101 and the light guide lens group 102. The laser beams emitted by the first sub-region P1 in the first laser-exit region Q1 and the second sub-region P2 in the second laser-exit region Q2 in the laser device 101 may be homogenized by the first fly-eye lens 107 and then emitted to the first light guide lens 1021.

In some embodiments, the first fly-eye lens 107 is located between the light guide lens group 102 and the combining lenses. In this case, the laser beam emitted by the second light guide lens 1022 may be homogenized by the first fly-eye lens 107 and then emitted to the first combining lens 103 and the second combining lens 104.

The first fly-eye lens 107 has a limiting effect on etendue. The first fly-eye lens 107 is configured to allow a laser beam having an incident angle less than an aperture angle of the first fly-eye lens 107 to be emitted at the aperture angle of the first fly-eye lens 107.

In some embodiments of the present disclosure, after the laser beams of the plurality of colors emitted by the laser device 101 are transmitted through the first fly-eye lens 107, the divergence angles of the laser beams of different colors may be adjusted to the aperture angles of the first fly-eye lens 107, respectively, so that the consistency of the sizes of the beam spots formed by the laser beams of the plurality of colors may be improved, thereby improving the light mixing effect of the laser beams of the plurality of colors. The first fly-eye lens 107 may further homogenize the incident laser beam and reduce the coherence between the laser beams, thereby further improving the light mixing effect of the laser beams of different colors, reducing the speckle effect of the projection image formed by the laser beams, and improving the display effect of the projection image.

In some embodiments, as shown in FIG. 12A, the first fly-eye lens 107 may be formed by a plurality of microlenses 1071 arranged in an array. A diameter of each microlens 1071 may be in an order of millimeters, micrometers, or nanometers. For example, a length of each microlens 1071 in the first fly-eye lens 107 in the slow axis direction of the incident laser beam is greater than a length of that in the fast axis direction. For example, the fast axis direction is parallel to the first direction, that is, a direction perpendicular to a plane where the Z direction and the Y direction are located in FIG. 12A, and the slow axis direction is parallel to the second direction, that is, the Y direction in FIG. 12A.

The aperture angle of the microlens 1071 is positively correlated with the diameter of the microlens 1071, and the aperture angle of the microlens 1071 in the slow axis direction may be greater than the aperture angle of that in the fast axis direction. Since the laser beam emitted towards the first fly-eye lens 107 has a large divergence angle in the slow axis direction, it may be ensured that the aperture angles in different directions in the first fly-eye lens 107 is matched with the divergence angles of the laser beam in the directions by providing the first fly-eye lens 107. In this way, it may be ensured that in each direction, the aperture angle of the first fly-eye lens is greater than the divergence angle of the incident laser beam, and the first fly-eye lens 107 may adjust the divergence angles of the laser beams of the plurality of colors to be basically consistent in each direction.

In some embodiments, the position of the first fly-eye lens 107 may be fixed and remain stationary relative to the laser device 101. Alternatively, when the laser device 101 emits the laser beam, the first fly-eye lens 107 may also move relative to the laser device 101. For example, the first fly-eye lens 107 may move back and forth within a certain range in the first direction or may move back and forth within a certain range in the second direction. The range may be small, so that in a case where the first fly-eye lens 107 moves to any position, the laser beam emitted by the laser device 101 may be emitted into the first fly-eye lens 107.

FIG. 12B is a side view of another projection laser source provided with a fly-eye lens, in accordance with some embodiments of the present disclosure.

In some embodiments, as shown in FIG. 12B, the projection laser source 10 may further include a first fly-eye lens 107. The first fly-eye lens 107 may be located between the laser device 101 and the combining lenses (i.e., the sixth combining lens 102′, the seventh combining lens 103′, and the third combining lens 104′). An orthogonal projection of the first fly-eye lens 107 on the laser device 101 covers the first laser-exit region Q1, the second laser-exit region Q2, and the third laser-exit region Q3. The laser beam emitted by the laser device 101 may be homogenized by the first fly-eye lens 107 and then emitted to the sixth combining lens 102′, the seventh combining lens 103′, and the third combining lens 104′.

For example, the laser beam emitted by the first laser-exit region Q1 is homogenized by the first fly-eye lens 107 and then emitted to the sixth combining lens 102′, the laser beam emitted by the second laser-exit region Q2 is homogenized by the first fly-eye lens 107 and then emitted to the seventh combining lens 103′, and the laser beam emitted by the third laser-exit region Q3 is homogenized by the first fly-eye lens 107 and then emitted to the third combining lens 104′.

Similarly, the composition, working principle and arrangement of the first fly-eye lens 107 may be referred to the example in FIG. 12A and will not be described in detail.

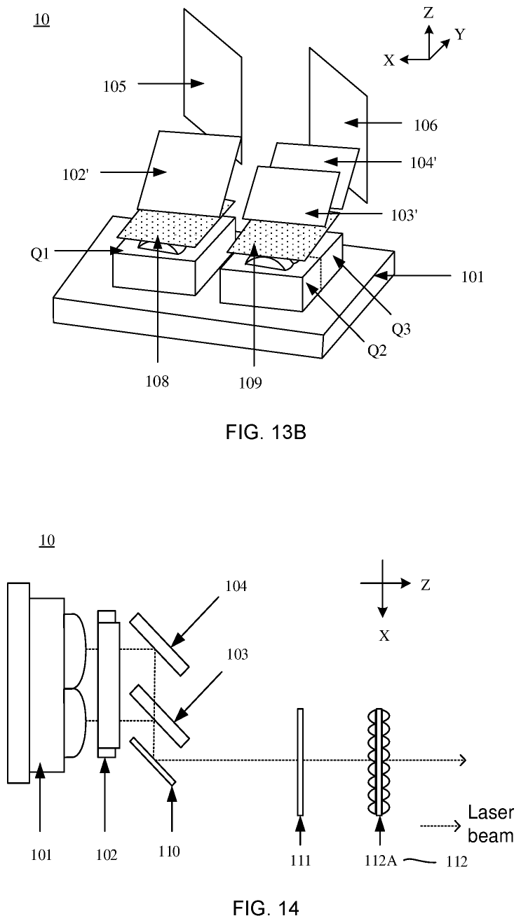

FIG. 13A is a perspective view of a projection laser source provided with a diffusion region, in accordance with some embodiments of the present disclosure.

In some embodiments, as shown in FIG. 13A, the projection laser source 10 may further include a first diffusion region 108 and a second diffusion region 109. A degree of diffusion of the incident laser beam by the first diffusion region 108 may be less than a degree of diffusion of the incident laser beam by the second diffusion region 109. An orthogonal projection of the first diffusion region 108 on the laser device 101 covers the first laser-exit region Q1, and an orthogonal projection of the second diffusion region 109 on the laser device 101 covers the second laser-exit region Q2 and the third laser-exit region Q3. The laser beam emitted by the first laser-exit region Q1 may be diffused by the first diffusion region 108, and then emitted to the first combining lens 103. The laser beams emitted by the second laser-exit region Q2 and the third laser-exit region Q3 may be diffused by the second diffusion region 109, and then emitted to the second combining lens 104.

It can be understood that the diffusion region may homogenize the incident laser beam and adjust the divergence angle of the laser beam. In some embodiments of the present disclosure, the degree of diffusion of the incident laser beam by the first diffusion region 108 is less than the degree of diffusion of the incident laser beam by the second diffusion region 109. In this way, the divergence angle of the laser beam emitted by the first diffusion region 108 may be close to the divergence angle of the laser beam emitted by the second diffusion region 109. In this way, it is conducive to improving the consistency of the sizes of the beam spots of the laser beams of the plurality of colors, improving the mixing effect and uniformity of the laser beams of the plurality of colors, and further improving the display effect of the projection image formed based on the mixed laser beam.

In some embodiments, the diffusion region may include a plurality of micro strip prisms arranged in parallel, and a cross-section of the prism may be in a shape of a triangle. The greater the vertex angle of the prism is, the greater the degree of diffusion of the incident light by the diffusion region is. The vertex angle refers to the angle of the triangular cross section of the micro strip prism that is away from the diffusion region.

In some embodiments of the present disclosure, the vertex angle of the micro strip prisms in the first diffusion region 108 may be less than the vertex angle of the micro strip prisms in the second diffusion region 109, and an arrangement density of the micro strip prisms in the first diffusion region 108 may be greater than an arrangement density of the micro strip prisms in the second diffusion region 109.

It will be noted that FIG. 13A is described by taking an example in which the two diffusion regions are located between the laser device 101 and the light guide lens group 102. The laser beams emitted by the first sub-region P1 in the first laser-exit region Q1 and the second sub-region P2 in the second laser-exit region Q2 in the laser device 101 may be homogenized by the two diffusion regions and then emitted to the first light guide lens 1021.

In some embodiments, the two diffusion regions may also be located between the light guide lens group 102 and the combining lenses. In this case, the laser beam emitted by the second light guide lens 1022 may be homogenized by the two diffusion regions, and then emitted to the first combining lens 103 and the second combining lens 104.

Some embodiments of the present disclosure are described by taking an example in which the first diffusion region 108 and the second diffusion region 109 are independently arranged. In some embodiments, the two diffusion regions may also be two portions of one diffusion region.

In some embodiments, the positions of the first diffusion region 108 and the second diffusion region 109 may be fixed and remain stationary relative to the laser device 101. Alternatively, in a case where the laser device 101 emits light, at least one of the first diffusion region 108 and the second diffusion region 109 may also move relative to the laser device 101.

For example, the diffusion region may move back and forth within a certain range in the first direction.

For example, the diffusion region may move back and forth within a certain range in the second direction.

For example, the diffusion region may also rotate or vibrate. In this case, a rotation axis of the diffusion region may be located at a center of the diffusion region.

For example, the diffusion region may also be flipped back and forth within a certain angle range.

For example, the diffusion region may also deviate from the center position of the diffusion region to a certain extent.

It will be noted that the range of the position change of the diffusion region may be relatively small, and in a case where the diffusion region moves to any position, the laser beam emitted by the laser device 101 may be emitted into the diffusion region.

Some embodiments of the present disclosure are described by taking an example in which the first diffusion region 108 and the second diffusion region 109 are flat plate shaped. For example, a light incident surface may be parallel with a light exit surface of the diffusion region.

In some embodiments, the diffusion region may also be wedge-shaped, and the light incident surface may not be parallel with the light exit surface of the diffusion region.

In some embodiments of the present disclosure, the first diffusion region 108 and the second diffusion region 109 are transmissive diffusion sheets.

It will be noted that the above-mentioned method of providing the light homogenizing component between the laser device 101 and the combining lens may also be used in other projection laser sources. For example, the method may also be used in the projection laser source in the related art.

In general, the projection laser source is further provided with a diffusion region in the beam path of the laser beams of different colors emitted by the laser device 101 after the laser beams of different colors are mixed so as to homogenize the mixed laser beams of different colors.

In some embodiments, in a case where the projection laser source 10 is provided with the first fly-eye lens 107, or the first diffusion region 108 and the second diffusion region 109 according to the above method, the projection laser source 10 may no longer be provided with a diffusion region in the beam path of the laser beams of the plurality of colors after the laser beams of the plurality of colors are mixed, so as to simplify the structure of the projection laser source, thereby facilitating the miniaturization of the projection laser source. Alternatively, the beam path of the laser beams of the plurality of colors after the laser beams of the plurality of colors are mixed may still provided with the diffusion region, so as to further homogenize the mixed laser beams of the plurality of colors.

FIG. 13B is a perspective view of another projection laser source provided with a diffusion region, in accordance with some embodiments of the present disclosure. As shown in FIG. 13B, the projection laser source 10 may also include a first diffusion region 108 and a second diffusion region 109. A degree of diffusion of the incident laser beam by the first diffusion region 108 may be less than a degree of diffusion of the incident laser beam by the second diffusion region 109. An orthogonal projection of the first diffusion region 108 on the laser device 101 covers the first laser-exit region Q1, and an orthogonal projection of the second diffusion region 109 on the laser device 101 covers the second laser-exit region Q2 and the third laser-exit region Q3. The laser beam emitted by the first laser-exit region Q1 may be diffused by the first diffusion region 108 and then emitted to the sixth combining lens 102′. The laser beam emitted by the second laser-exit region Q2 may be diffused by the second diffusion region 109 and then emitted to the seventh combining lens 103′. The laser beam emitted by the third laser-exit region Q3 may be diffused by the second diffusion region 109 and then emitted to the third combining lens 104′.

For example, the arrangement and working process of the diffusion region may be referred to the example in FIG. 13A, which will not be repeated in the present disclosure.

The arrangement of the diffusion region in the beam path after the laser beams of the plurality of colors are mixed in the projection laser source 10 will be described below with reference to the accompanying drawings. The arrangement of the diffusion region described below may be used for the projection laser source 10 described in any of the above embodiments. For ease of description, in some embodiments of the present disclosure, the arrangement of the diffusion region in the beam path after the laser beams of the plurality of colors are mixed in the projection laser source 10 will be described in detail based on the projection laser source 10 shown in FIG. 3A. It will be noted that the arrangement in the following example is also applicable to the projection laser source 10 described in FIG. 3B and some related embodiments.

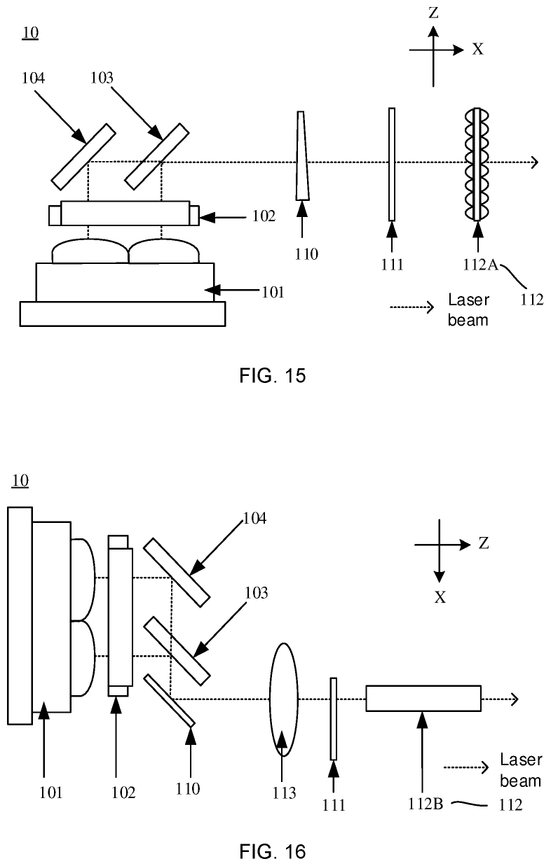

FIG. 14 is a structural diagram of yet another projection laser source, in accordance with some embodiments of the present disclosure. FIG. 15 is a structural diagram of yet another projection laser source, in accordance with some embodiments of the present disclosure.

As shown in FIG. 14 and FIG. 15, the projection laser source 10 may further include at least one diffusion region, and the at least one diffusion region is located on the transmission path of the laser beams emitted by the first combining lens 103 and the second combining lens 104. For example, the at least one diffusion region is located on a side of the first combining lens 103 away from the second combining lens 104. FIG. 14 and FIG. 15 illustrate an example in which the at least one diffusion region includes two diffusion regions, and the two diffusion regions are a third diffusion region 110 and a fourth diffusion region 111, respectively. In some embodiments, the at least one diffusion region may also include only one diffusion region.

In some embodiments, the degree of diffusion of incident laser beam by any one of the at least one diffusion region in the fast axis direction may be stronger than that in the slow axis direction. In a case where the laser beam is emitted towards the diffusion region, the divergence angle in the fast axis direction may be less than the divergence angle in the slow axis direction. For example, the divergence angle in the slow axis direction may be greater than 1 degree, and the divergence angle in the fast axis direction may be less than 1 degree.

In some embodiments of the present disclosure, the degree of diffusion of the diffusion region in the fast axis direction is made strong by adjusting the arrangement position of the diffusion region, so that the laser beam passes through the diffusion region, the divergence angles of the laser beam in the fast axis direction and the slow axis direction are close, thereby reducing an aspect ratio of the beam spot formed by the laser beam, which may satisfy the shape requirements of the laser beam emitted by the projection laser source.

In some embodiments of the present disclosure, any one of the third diffusion region 110 and the fourth diffusion region 111 may satisfy at least one of a first preset condition, a second preset condition or a third preset condition.

For example, the first preset condition includes that the diffusion region is one of a reflective diffusion sheet and a transmissive diffusion sheet.

For example, the second preset condition includes that the diffusion region is in one of a wedge shape and a flat plate shape.

For example, the third preset condition includes that the diffusion region satisfies one of a first sub-condition, a second sub-condition, a third sub-condition, and a fourth sub-condition.

The first sub-condition includes that the diffusion region is configured to remain stationary. The second sub-condition includes that the diffusion region is configured to translate within a target range. The third sub-condition includes that the diffusion region is configured to rotate along a target direction. The fourth sub-condition includes that the diffusion region is configured to flip within a target angle range.

In a case where the diffusion region moves, the range of position movement of the diffusion region may be small, so as to avoid moving out of the irradiation range of the laser beam. Any one of the third diffusion region 110 and the fourth diffusion region 111 may be implemented by any combination of the first preset condition, the second preset condition, and the third preset condition.

For example, the diffusion region may be a flat reflective diffusion sheet, and the diffusion region may be flipped back and forth within a range of 1 degree.

For example, the diffusion region may be a wedge-shaped transmissive diffusion sheet, and the diffusion region may move back and forth within a certain range along the second direction.

For example, the diffusion region may be a flat plate shaped transmissive diffusion sheet, which is rotatable in a clockwise direction with its center as a rotation axis.

It can be understood that the diffusion region may further have a plurality of implementations, and details will not be repeated herein.

For example, as shown in FIG. 14, the third diffusion region 110 may be a reflective diffusion sheet, the fourth diffusion region 111 may be a transmissive diffusion sheet, and the two diffusion regions are in a flat plate shape. The second combining lens 104, the first combining lens 103, and the third diffusion region 110 may be arranged along the X direction, and the third diffusion region 110 and the fourth diffusion region 111 may be arranged along the Z direction. The laser beam emitted by the first combining lens 103 along the X direction may be diffused by the third diffusion region 110 and reflected along the Z direction to the fourth diffusion region 111. The fourth diffusion region 111 further diffuses the incident laser beam and emits the laser beam along the Z direction.

In some embodiments, the third diffusion region 110 may be flipped back and forth within a range of 1 degree or 2 degrees with the Y direction as a flipping axis. During the flipping process, the laser beam emitted by the third diffusion region 110 will be displaced in the X direction. Therefore, the phase of the laser beam emitted by the third diffusion region 110 is random, thereby reducing the speckle effect of the projection image formed by the laser beam.

As shown in FIG. 15, the third diffusion region 110 and the fourth diffusion region 111 may be transmissive diffusion sheets. The third diffusion region 110 is in a wedge shape, and the fourth diffusion region 111 is in a flat plate shape. The second combining lens 104, the first combining lens 103, the third diffusion region 110, and the fourth diffusion region 111 may be disposed along the X direction. The laser beam emitted by the first combining lens 103 along the X direction may be diffused by the third diffusion region 110 and the fourth diffusion region 111 in sequence and emitted along the X direction.

In some embodiments, the third diffusion region 110 rotates with a center thereof as the rotation axis. The third diffusion region 110 is in a wedge shape, and the laser beam emitted by the third diffusion region 110 may be deflected towards a side where a wide portion of the third diffusion region 110 is located. During the process of the rotation of the third diffusion region 110, a position of the laser beam emitted by the diffusion region 110 may continuously move along a rotation direction. Therefore, the phase of the laser beam emitted by the third diffusion region 110 is random, thereby reducing the speckle effect of the projection image formed by the laser beam.

In some embodiments, as shown in FIGS. 14 and 15, the projection laser source 10 may further include a light homogenizing component 112. The light homogenizing component 112 may be used as a light-emitting component of the projection laser source 10 and is located at an end of the beam path in the projection laser source 10. The light homogenizing component 112 may collect and homogenize the laser beam and then emit the laser beam to the subsequent modulated beam path, so as to facilitate the subsequent image projection.

As shown in FIGS. 14 and 15, the light homogenizing component 112 may include a second fly-eye lens 112A. The third diffusion region 110 and the fourth diffusion region 111 may be located between the combining lens and the second fly-eye lens 112A.

In some embodiments, a distance between the fourth diffusion region 111 and the second fly-eye lens 112A may be greater than or equal to 10 mm. For example, the distance between the fourth diffusion region 111 and the second fly-eye lens 112A is 10 mm, 12 mm, 15 mm, 20 mm, 30 mm, 50 mm, or 100 mm.

In this way, the laser beam may be transmitted from the diffusion region to the second fly-eye lens 112A for a longer distance, so that the beam spot may be expanded to a certain extent. Since the etendue of the second fly-eye lens 112A to the incident laser beam is an integral of the area and the incident angle, the second fly-eye lens 112A emits more laser beam and has a good light homogenization effect on the laser beam.

FIG. 16 is a structural diagram of yet another projection laser source, in accordance with some embodiments of the present disclosure.

As shown in FIG. 16, the light homogenizing component 112 in the projection laser source 10 may include a light pipe 112B. In this case, a converging lens 113 may be further disposed between the light homogenizing component 112 and the third diffusion region 110, so as to converge the laser beam to the light inlet of the light pipe 112B. The third diffusion region 110, the condensing lens 113, the fourth diffusion region 111, and the light pipe 112B may be arranged in sequence.

In some embodiments, the third diffusion region 110 and the fourth diffusion region 111 may also be located in the beam path before the converging lens 113, which is not limited in the present disclosure. A length direction of the light inlet of the light pipe 112B may be parallel to the slow axis direction of the laser beam (i.e., the slow axis direction of the incident laser beam), and a width direction of the light inlet may be parallel to the fast axis direction of the laser beam, so as to ensure that the beam spot formed by the laser beam at the light inlet of the light pipe 112B is matched with the shape of the light inlet.

To sum up, in the projection laser source provided by some embodiments of the present disclosure, the light guide lens group may adjust the laser beam emitted by the first sub-region P1 at the end of the first laser-exit region and the laser beam emitted by the second sub-region P2 at the same end of the second laser-exit region to be emitted by the side of the third laser-exit region away from the second laser-exit region towards the first combining lens and the second combining lens, respectively. In this way, the laser beam from the second laser-exit region may be located on both sides of the laser beam emitted by the third laser-exit region when being emitted to the second combining lens, thereby improving the symmetry of the laser beam from the second laser-exit region and the laser beam from the third laser-exit region. In this way, it is conducive to improving the symmetry and uniformity of the laser beams of the plurality of colors after mixing through the first combining lens and the second combining lens, and further conducive to improving the display effect of the projection image formed based on the laser beams.

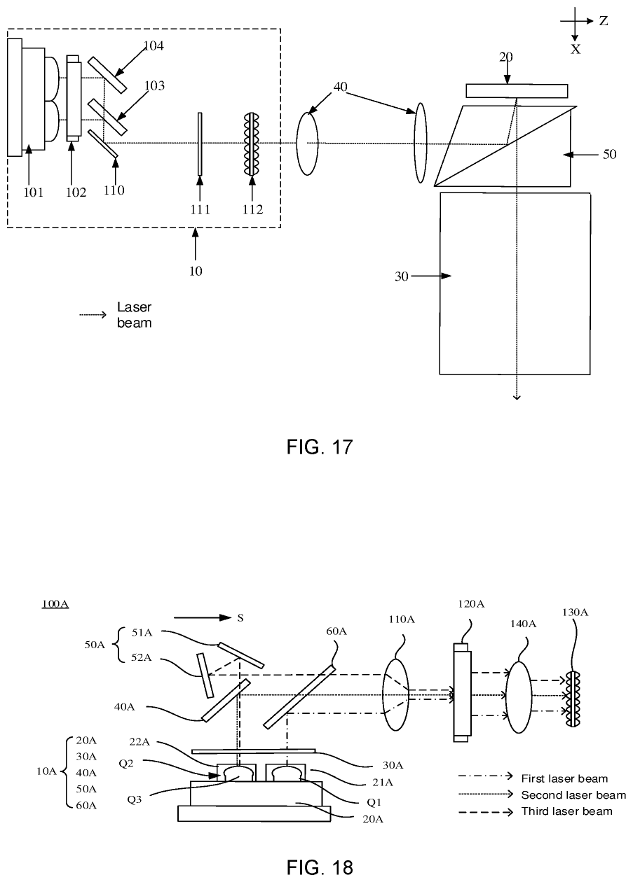

FIG. 17 is a structural diagram of a projection apparatus, in accordance with some embodiments of the present disclosure.

As shown in FIG. 17, the projection apparatus may include the projection laser source 10, a light valve 20, and a projection lens 30. The projection laser source may be any one of the projection laser sources described above, such as any one of the projection laser sources in FIGS. 3A to 16. FIG. 17 takes the projection apparatus including the projection laser source shown in FIG. 14 as an example.

In some embodiments, the projection apparatus may further include an illumination lens group 40 and a total internal reflection prism 50 located between the projection laser source 10 and the light valve 20. The laser beam emitted by the projection laser source 10 may be emitted towards the illumination lens group 40, so as to be converged by the illumination lens group 40 and emitted towards the total internal reflection prism 50. Thus, the total internal reflection prism 50 reflects the incident laser beam towards the light valve 20. The light valve 20 is configured to modulate the incident laser beam and emit the laser beam towards the lens 30, and the lens 30 is configured to project the incident laser beam to form a projection image.

For example, the light valve 20 may include a plurality of reflective sheets, any one of the plurality of reflective sheets may be configured to form a pixel in the projection image. The plurality of reflective sheets may be adjusted according to an image to be displayed, so that the reflective sheets corresponding to the pixels in the image that need to be displayed in a bright state reflect the laser beams to the projection lens, so as to achieve the modulation of the illumination beams.

For example, the projection lens 30 may be a telephoto lens or an ultra short focal length lens. The projection lens may include a plurality of lenses, and the plurality of lenses may be arranged along a certain direction. The laser beams emitted by the light valve 20 may be sequentially emitted to the screen through the plurality of lenses in the projection lens 30, so as to implement the projection of the laser beams by the projection lens and implement the display of the projection image.

In the projection apparatus provided by some embodiments of the present disclosure, the symmetry of the laser beams of the plurality of colors emitted by the projection laser source is high, and the consistency of the beam spots is good, so that a projection image with good display effect may be formed based on the laser beams emitted by the projection laser source.

Some embodiments of the present disclosure provide another projection laser source.

As shown in FIG. 18, the projection laser source 10A includes a laser device 20A, a diffusion component 30A, a first light guide lens group 40A, a second light guide lens group 50A, and a dichroic combining lens 60A.

The laser device 20A includes a first tube shell 21A, a second tube shell 22A, a first laser-exit region Q1, a second laser-exit region Q2, and a third laser-exit region Q3. The first tube shell 21A is located at a side of the second tube shell 22A along a predetermined direction (e.g., an S direction).

For example, the first laser-exit region is packaged and configured to emit a first laser beam. The second laser-exit region is configured to emit a second laser beam. The third laser-exit region is configured to emit a third laser beam. The second laser-exit region and the third laser-exit region are packaged.

The first laser-exit region Q1 is disposed in the first tube housing 21A, and configured to emit a first laser beam. The second laser-exit region Q2 is disposed in the second tube shell 22A and configured to emit a second laser beam. The third laser-exit region Q3 is disposed in the second tube shell 22A and configured to emit a third laser beam.

Colors of the first laser beam, the second laser beam, and the third laser beam are different. For example, the first laser beam is a red laser beam, the second laser beam is a blue laser beam, and the third laser beam is a green laser beam.

The diffusion component 30A is parallel to a laser-exit surface of the laser device 20A, and configured to diffuse the first laser beam, the second laser beam, and the third laser beam.

The first light guide lens group 40A is configured to reflect and guide the second laser beam towards the dichroic combining lens 60A.

The second light guide lens group 50A is configured to guide the third laser beam to the dichroic combining lens 60A.

The dichroic combining lens 60A is configured to reflect the first laser beam from the diffusion component 30A in a predetermined direction and transmit the third laser beam from the second light guide lens group 50A and the second laser beam from the first light guide lens group 40A in the predetermined direction, so as to form a mixed laser beam.

In some embodiments, the second light guide lens group 50A includes a first dimming region 51A and a second dimming region 52A. The first dimming region 51A is configured to reflect the third laser beam from the first light guide lens group 40A to the second dimming region. The second dimming region 52A is configured to reflect the third laser beam from the first dimming region to the dichroic combining lens 60A.

In some embodiments, the diffusion component 30A satisfies at least one of the following: the diffusion component 30A is one of a reflective diffusion sheet and a transmissive diffusion sheet; or the diffusion component 30A is in one of a wedge shape and a flat plate shape.

In some embodiments, the diffusion component 30A satisfies at least one of the following: the diffusion component 30A is configured to remain stationary; the diffusion component 30A is configured to translate within a target range; the diffusion component 30A is configured to rotate along a target direction; or the diffusion component 30A is configured to flip within a target angle range.

In some embodiments, the diffusion component 30A includes a third diffusion region, a fourth diffusion region, and a fifth diffusion region. The third diffusion region is located at a laser-exit side of the first laser-exit region Q1 and is configured to diffuse the first laser beam. The fourth diffusion region is located at a laser-exit side of the second laser-exit region Q2 and is configured to diffuse the second laser beam. The fifth diffusion region is located at a laser-exit side of the third laser-exit region Q3 and is configured to diffuse the third laser beam.

Some embodiments of the present disclosure provide another projection apparatus 100A. As shown in FIG. 18, the projection apparatus 100A includes the projection laser source 10A described in any one of the above embodiments, a second converging lens 110A, a diffusion wheel 120A, and a third fly-eye lens 130A.

The projection laser source 10A is configured to output a mixed laser beam obtained by mixing the first laser beam, the second laser beam, and the third laser beam. The second converging lens 110A is located at a laser-exit side of the projection laser source 10A and is configured to converge the mixed laser beam. The diffusion wheel 120A is located at a laser-exit side of the second converging lens 110A and is configured to diffuse the converged mixed laser beam. The third fly-eye lens 130A is located at a laser-exit side of the diffusion wheel 120A and is configured to homogenize the diffused mixed laser beam.

In some embodiments, the projection apparatus 100A further includes a light valve and a projection lens. The light valve is located at a laser-exit side of the third fly-eye lens 130A and is configured to modulate the homogenized mixed laser beam. The projection lens is located at a laser-exit side of the light valve and is configured to project the modulated mixed laser beam to form a projection image.

In some embodiments, projection apparatus 100A further includes a third converging lens 140A. The third converging lens 140A is disposed between the diffusion wheel 120A and the third fly-eye lens 130A and is configured to converge the mixed laser beam from the diffusion wheel 120A and transmit the mixed laser beam to the third fly-eye lens 130A.

In some embodiments, the diffusion wheel 120A has a rotation axis, and the diffusion wheel 120A is rotatable about the rotation axis.

It will be noted that any technical solution disclosed in the present disclosure may to some extent solve one or more technical problems and implement certain disclosure objectives. A plurality of technical solutions may also be combined into a comprehensive solution to solve one or more technical problems and implement certain disclosure objectives. It is also possible to choose a combination of partially disclosed technologies to form a comprehensive solution, while adopting relevant art and degradation solutions. However, the technology disclosure method may compensate for the degradation trend and solve one or more technical problems to a certain extent, as well as achieve certain disclosure objectives. Each technology disclosure combined into a complete technical solution constitutes an organic and inseparable overall solution, which solves technical problems and achieves certain disclosure objectives as a whole.

Any technical disclosure in the present disclosure, as well as the recombination of the plurality of technical disclosures, can form a complete technical solution, and can solve one or more of the above-mentioned technical problems to achieve the disclosure purpose, which belongs to the content of the present disclosure and is directly and unambiguously determined based on the content of the present disclosure.

The foregoing descriptions are merely specific implementations of the present disclosure, but the protection scope of the present disclosure is not limited thereto. Changes or replacements that any person skilled in the art could conceive of within the technical scope of the present disclosure shall be included in the protection scope of the present disclosure. Therefore, the protection scope of the present disclosure shall be subject to the protection scope of the claims.

What is claimed is:

1. A projection laser source, comprising:
a laser device including a first laser-exit region, a second laser-exit region, and a third laser-exit region configured to emit laser beams of different colors, respectively; wherein the second laser-exit region and the third laser-exit region are located at a same side of the first laser-exit region in a first direction and are arranged along a second direction; the first direction is perpendicular to the second direction; the second laser-exit region includes a second sub-region, and the second sub-region is a partial region of an end of the second laser-exit region away from the third laser-exit region; the first laser-exit region includes a first sub-region; and along the first direction, the first sub-region is a partial region of the first laser-exit region corresponding to the second sub-region;
a light guide lens group configured to adjust a laser beam emitted by the first sub-region and a laser beam emitted by the second sub-region to be emitted towards the first combining lens and the second combining lens respectively from a side of the third laser-exit region away from the second laser-exit region; wherein a laser beam emitted by a region other than the first sub-region in the first laser-exit region is emitted to the first combining lens; and a laser beam emitted by a region other than the second sub-region in the second laser-exit region and a laser beam emitted by the third laser-exit region are emitted to the second combining lens;
a first combining lens; and
a second combining lens; the first combining lens and the second combining lens being located at a side of the light guide lens group away from the laser device, and the first combining lens and the second combining lens being configured to emit the incident laser beam along the first direction.

2. The projection laser source according to claim 1, wherein the light guide lens group includes:
a first light guide lens, and an orthogonal projection of the first light guide lens on the laser device covering the first sub-region and the second sub-region; and
a second light guide lens, and an orthogonal projection of the second light guide lens on the laser device being located at a side of the third laser-exit region away from the second laser-exit region; the first light guide lens and the second light guide lens are arranged along the second direction;
wherein the laser beam emitted by the first sub-region and the laser beam emitted by the second sub-region are emitted towards the first light guide lens; the first light guide lens is configured to reflect the incident laser beam towards the second light guide lens;
and the second light guide lens is configured to reflect the incident laser beam from the first sub-region towards the first combining lens and reflect the incident laser beam from the second sub-region towards the second combining lens.

3. The projection laser source according to claim 2, satisfying one of the following:
the first light guide lens including:
a first reflecting sub-region, and an orthogonal projection of the first reflecting sub-region on the laser device covering the first sub-region; and
a second reflecting sub-region, and an orthogonal projection of the second reflecting sub-region on the laser device covering the second sub-region;
the second light guide lens including:
a third reflecting sub-region, and the first reflecting sub-region and the third reflecting sub-region being arranged along the second direction; wherein the laser beam emitted by the first sub-region is emitted towards the first reflecting sub-region, and the first reflecting sub-region is configured to reflect the incident laser beam towards the third reflecting sub-region; the third reflecting sub-region is configured to reflect the incident laser beam towards the first combining lens; and
a fourth reflecting sub-region, and the second reflecting sub-region and the fourth reflecting sub-region being arranged along the second direction; wherein the laser beam emitted by the second sub-region is emitted towards the second reflecting sub-region, and the second reflecting sub-region is configured to emit the incident laser beam towards the fourth reflecting sub-region; the fourth reflecting sub-region is configured to reflect the incident laser beam towards the second combining lens;
or,
the first light guide lens including:
a first reflecting sub-region, and an orthogonal projection of the first reflecting sub-region on the laser device covering the first sub-region; and
a second reflecting sub-region, and an orthogonal projection of the second reflecting sub-region on the laser device covering the second sub-region;
the second light guide lens including:
the third reflecting sub-region, and the first reflecting sub-region and the third reflecting sub-region being arranged along the second direction; wherein the laser beam emitted by the first sub-region is emitted towards the first reflecting sub-region, and the first reflecting sub-region is configured to reflect the incident laser beam towards the third reflecting sub-region; the third reflecting sub-region is configured to reflect the incident laser beam towards the first combining lens; and
the fourth reflecting sub-region, and the second reflecting sub-region and the fourth reflecting sub-region being arranged along the second direction; wherein the laser beam emitted by the second sub-region is emitted towards the second reflecting sub-region, and the second reflecting sub-region is configured to emit the incident laser beam towards the fourth reflecting sub-region; the fourth reflecting sub-region is configured to reflect the incident laser beam towards the second combining lens;
wherein the laser device and the third reflecting sub-region are located at a same side of the first reflecting sub-region, and the first reflecting sub-region and the first combining lens are located at a same side of the third reflecting sub-region;
the laser device and the fourth reflecting sub-region are located at a same side of the second reflecting sub-region, and the second reflecting sub-region and the second combining lens are located at a same side of the fourth reflecting sub-region.

4. The projection laser source according to claim 1, wherein a divergence angle of the laser beam emitted by the first laser-exit region is greater than divergence angles of the laser beams emitted by the second laser-exit region and the third laser-exit region;
the projection laser source further includes a first fly-eye lens; the first fly-eye lens is located between the laser device and the light guide lens group, and an orthogonal projection of the first fly-eye lens on the laser device covers the first laser-exit region, the second laser-exit region, and the third laser-exit region; the first fly-eye lens is configured to homogenize laser beams emitted by the laser device, and then emit the laser beams to the light guide lens group, the first combining lens, and the second combining lens.

5. The projection laser source according to claim 1, further comprising a first fly-eye lens;
wherein the first fly-eye lens includes a plurality of microlenses, and a length of one of the plurality of microlenses in a slow axis direction of an incident laser beam is greater than a length in a fast axis direction of the incident laser beam;
the first fly-eye lens is located between the light guide lens group and the first combining lens, and located between the light guide lens group and the second combining lens; the first fly-eye lens is configured to homogenize laser beams from the light guide lens group and the laser beam, and then emit the laser beams to the first combining lens and the second combining lens, respectively.

6. The projection laser source according to claim 1, wherein a divergence angle of the laser beam emitted by the first laser-exit region is greater than a divergence angle of the laser beam emitted by the second laser-exit region and a divergence angle of the laser beam emitted by the third laser-exit region, respectively;
the projection laser source further includes:
a first diffusion region; an orthogonal projection of the first diffusion region on the laser device covering the first laser-exit region, and the laser beam emitted by the first laser-exit region being diffused by the first diffusion region and then emitted to the first combining lens; and
a second diffusion region; an orthogonal projection of the second diffusion region on the laser device covering the second laser-exit region and the third laser-exit region, and the laser beams emitted by the second laser-exit region and the third laser-exit region being diffused by the second diffusion region and then emitted to the second combining lens;
wherein a degree of diffusion of a laser beam by the first diffusion region is different from a degree of diffusion of a laser beam by the second diffusion region.

7. The projection laser source according to claim 6, wherein the degree of diffusion of the laser beam by the first diffusion region is less than the degree of diffusion of the laser beam by the second diffusion region.

8. The projection laser source according to claim 1, further comprising at least one diffusion member, and the at least one diffusion member being located on transmission paths of the laser beams emitted by the first combining lens and the second combining lens;
a degree of diffusion of incident laser beam by the diffusion member in a fast axis direction may be stronger than that in a slow axis direction.

9. The projection laser source according to claim 8, wherein the diffusion member satisfies at least one of a first preset condition or a third preset condition;
the first preset condition includes that the diffusion member is one of a reflective diffusion sheet and a transmissive diffusion sheet;
the third preset condition includes that the diffusion member satisfies one of a first sub-condition, a second sub-condition, a third sub-condition, and a fourth sub-condition; wherein the first sub-condition includes that the diffusion member is configured to remain stationary; the second sub-condition includes that the diffusion member is configured to translate within a target range; the third sub-condition includes that the diffusion member is configured to rotate along a target direction; and the fourth sub-condition includes that the diffusion member is configured to flip within a target angle range.

10. The projection laser source according to claim 8, further comprising a light homogenizing component; the projection laser source satisfying one of the following:
the light homogenizing component being located on a transmission path of a laser beam emitted by the at least one diffusion member, and configured to homogenize an incident laser beam and transmit the homogenized laser beam to outside of the projection laser source;
the light homogenizing component being located on a transmission path of a laser beam emitted by the at least one diffusion member, and configured to homogenize an incident laser beam and transmit the homogenized laser beam to outside of the projection laser source; the light homogenizing component including a second fly-eye lens, and the at least one diffusion member being located between the first combining lens and the second fly-eye lens; and
the light homogenizing component being located on a transmission path of a laser beam emitted by the at least one diffusion member, and configured to homogenize an incident laser beam and transmit the homogenized laser beam to outside of the projection laser source; the light homogenizing component including a light pipe; the projection laser source further including a first converging lens; and the at least one diffusion member, the first converging lens, and the light pipe being arranged in sequence.

11. A projection apparatus, comprising: the projection laser source according to claim 1, a light valve and a projection lens;
wherein the projection laser source is configured to emit laser beam towards the light valve; the light valve is configured to modulate and emit the incident laser beam towards the projection lens; and the projection lens is configured to project the incident laser beam to provide a projection image.

12. A projection laser source, comprising:
a laser device including:
a first laser-exit region being packaged, and configured to emit a first laser beam;
a second laser-exit region configured to emit a second laser beam; and
a third laser-exit region configured to emit a third laser beam; the second laser-exit region and the third laser-exit region being packaged; wherein colors of the first laser beam, the second laser beam and the third laser beam are different;
a diffusion component parallel to a laser-exit surface of the laser device, and configured to diffuse the first laser beam, the second laser beam, and the third laser beam;
a first light guide lens group configured to reflect and guide the second laser beam to a dichroic combining lens;
a second light guide lens group configured to guide the third laser beam to the dichroic combining lens;
the dichroic combining lens configured to reflect the first laser beam from the diffusion component in a predetermined direction, and transmit the third laser beam from the second light guide lens group and the second laser beam from the first light guide lens group in the predetermined direction, so as to form a mixed laser beam.

13. The projection laser source according to claim 12, wherein the second light guide lens group includes:
a first dimming region configured to reflect the third laser beam from the first light guide lens group to the second dimming region; and
a second dimming region configured to reflect the third laser beam from the first dimming region to the dichroic combining lens.

14. The projection laser source according to claim 12, wherein the diffusion component satisfies at least one of the following:
the diffusion component is one of a reflective diffusion sheet and a transmissive diffusion sheet; or
the diffusion component is in one of a wedge shape and a flat plate shape.

15. The projection laser source according to claim 12, wherein the diffusion component satisfies at least one of the following:
the diffusion component is configured to remain stationary;
the diffusion component is configured to translate within a target range;
the diffusion component is configured to rotate in a target direction; or
the diffusion component is configured to flip within a target angle range.

16. The projection laser source according to claim 12, wherein the diffusion component includes:
a third diffusion region located at a laser-exit side of the first laser-exit region, and configured to diffuse the first laser beam;
a fourth diffusion region located at a laser-exit side of the second laser-exit region, and configured to diffuse the second laser beam; and
a fifth diffusion region located at a laser-exit side of the third laser-exit region, and configured to diffuse the third laser beam.

17. A projection apparatus, comprising:
the projection laser source according to claim 12, and the projection laser source being configured to output a mixed laser beam provided by mixing the first laser beam, the second laser beam, and the third laser beam;
a second converging lens located at a laser-exit side of the projection laser source, and configured to converge the mixed laser beam;
a diffusion wheel located at a laser-exit side of the second converging lens, and configured to diffuse the converged mixed laser beam; and
a third fly-eye lens located at a laser-exit side of the diffusion wheel, and configured to homogenize the diffused mixed laser beam.

18. The projection apparatus according to claim 17, further comprising
a light valve located at a laser-exit side of the third fly-eye lens, and configured to modulate the homogenized mixed laser beam; and
a projection lens located at a laser-exit side of the light valve, and configured to project the modulated mixed laser beam to provide a projection image.

19. The projection apparatus according to claim 17, further comprising a third converging lens; the third converging lens being disposed between the diffusion wheel and the third fly-eye lens, and configured to converge and emit the mixed laser beam from the diffusion wheel to the third fly-eye lens.

20. The projection apparatus according to claim 17, wherein the diffusion wheel has a rotation axis, and the diffusion wheel is rotatable about the rotation axis.
